(19) United States
(12) Patent Application Publication
(10) Pub. No.: US 2024/0393294 A1
(43) Pub. Date: Nov. 28, 2024

(54) METHOD FOR MEASURING CHANGE IN PHYSICAL QUANTITY OF ADHERED SUBSTANCE BY QCM SENSOR

(71) Applicant: NISSAN CHEMICAL CORPORATION, Tokyo (JP)

(72) Inventors: Hirotake KITAGAWA, Sodegaura-shi (JP); Kotatsu MATSUBARA, Funabashi-shi (JP); Takahiro OHORI, Sodegaura-shi (JP); Masaya KASHIHARA, Sodegaura-shi (JP)

(73) Assignee: NISSAN CHEMICAL CORPORATION, Tokyo (JP)

(21) Appl. No.: 18/695,679

(22) PCT Filed: Sep. 27, 2022
(86) PCT No.: PCT/JP2022/035992

§ 371 Date: Jun. 4, 2024

(30) Foreign Application Priority Data
Sep. 27, 2021 (JP) 2021-157159

(51) Int. Cl. G01N 29/02; G01N 29/036; G01N 29/22

(52) U.S. Cl. CPC G01N 29/022; G01N 29/036; G01N 29/222

(57) ABSTRACT

A measurement method for a physical quantity change of an adhered substance that changes due to external stimulation includes: measuring a physical quantity change of the adhered substance on an adhesion target by causing a detection unit, in which the adhesion target and the adhered substance placed thereon are on a sensor including a crystal resonator, so as to resonate in a medium; and measuring change in a resonance frequency of the crystal resonator caused by external stimulation to the detection unit, wherein the external stimulation is chemical injection or a temperature change, wherein the change in the physical quantity is a change in an elastic modulus of the adhered substance, a change in an elastic modulus of a laminated part due to detachment of the adhered substance or a change in weight of the adhered substance, and wherein the medium is gas or liquid.

### TECHNICAL FIELD

The present invention relates to a method for measuring a change in a physical quantity such as a weight or elastic modulus of an adhered substance on an adhesion target in a medium using a quartz crystal microbalance (QCM) method, and relates to a method for observing a change in a state through the method.

### BACKGROUND ART

When a voltage is applied to a crystal resonator, an inverse piezoelectric phenomenon in which it vibrates occurs. In addition, it is known that, when the weight of the crystal resonator part changes due to adhering of a substance to the surface of the crystal resonator or peeling off an adhered material, the resonance frequency of the crystal resonator changes. A QCM sensor is a means for measuring the weight and concentration of adhered substances based on this frequency change.

Various sensors that utilize these properties of crystal resonators have been proposed so far. For example, a concentration sensor which detects the concentration of a detection target substance in a mixed solution obtained by dissolving a predetermined detection target substance in a predetermined solvent, and includes a crystal resonator whose natural frequency changes according to a change in the concentration of the detection target substance and an oscillation circuit that oscillates the crystal resonator, wherein the crystal resonator is impregnated into the mixed solution and oscillated, the natural frequency of the crystal resonator at that time is determined, and thus the concentration of the detection target substance in the mixed solution is determined has been disclosed (Patent Document 1).

As a sensor for measuring environmental pollutants, a detection sensor in which cyclodextrin derivatives that bind to a specific substance are fixed to an electrode provided on a crystal resonator, wherein the cyclodextrin derivatives are fixed to the electrode using a disulfide compound or a thiol compound has been disclosed (Patent Document 2).

A method in which a sublimate from a thermosetting film during heating is adhered to the surface of a crystal resonator through a nozzle built into a detection part, and the amount of the sublimate is measured in real time as the heating time elapses from the change in resonance frequency according to the amount of the sublimate adhered to the crystal resonator has been disclosed (Patent Document 3).

It is described that sublimates of several types of lower antireflection films are quantified and compared under heating at 200° C. using a QCM sensor (Non-Patent Document 1). This document reports that, in measurement of sublimates of antireflection films applied to a 4-inch wafer, differences between materials can be confirmed by baking and measuring several tens of wafers.

### PRIOR ART DOCUMENTS

### Patent Documents

Patent Document 1: JP H6-18394 A
Patent Document 2: JP 2004-177258 A
Patent Document 3: WO 2007/111147

### Non-Patent Documents

Non-Patent Document 1: SPIE Vol. 5753 2005, pp. 655 to 662

### SUMMARY OF THE INVENTION

### Problem to be Solved by the Invention

The relationship between the ease of adhesion of the adhesion target and the adhered substance and the ease of peeling off may change depending on the type and magnitude of external stimulation in the medium. A certain degree of correlation can be determined depending on the degree of specific external stimulation in the adsorption-desorption or adhesion-detachment relationship between the adhesion target and the adhered substance. When the ease of adhesion of the adhered substance on a specific adhesion target and the ease of peeling off are measured by utilizing this relationship, it can be expected to clarify the adsorption and desorption mechanism and provide useful information for a material design involving the adhesion target and the adhered substance under an external environment.

The present invention provides a method for measuring a change in a physical quantity such as a weight or elastic modulus of an adhered substance on an adhesion target using a QCM sensor, and the change in a state caused by the change in the physical quantity is observed.

### Means for Solving the Problem

The present invention provides, as a first aspect, a measurement method for a change in a physical quantity of an adhered substance that changes due to external stimulation, comprising measuring a change in a physical quantity of an adhered substance on an adhesion target by causing a detection unit in which an adhesion target (a) and an adhered substance (b) on the adhesion target (a) are applied onto a sensor including a crystal resonator in an overlapping manner to resonate in a medium (d), and measuring an amount of change in a resonance frequency of the crystal resonator caused by external stimulation (c) to the detection unit,
as a second aspect, the measurement method according to the first aspect, wherein the external stimulation (c) is chemical injection or a temperature change,
as a third aspect, the measurement method according to the first aspect, wherein the change in the physical quantity is a change in an elastic modulus of the adhered substance,
as a fourth aspect, the measurement method according to the first aspect, wherein the change in the physical quantity is a change in an elastic modulus of a laminated part composed of the adhesion target and the adhered substance due to detachment of the adhered substance from the adhesion target,
as a fifth aspect, the measurement method according to the first aspect, wherein the change in the physical quantity is a change in a weight of the adhered substance,
as a sixth aspect, the measurement method according to the first aspect, wherein the medium (d) is a gas or a liquid,
as a seventh aspect, the measurement method according to the first aspect, wherein the a (adhesion target), the b (adhered substance), the c (external stimulation), and the d (medium) are a (bedrock), b (oil), c (administration of a chemical solution for recovery), and d (salt water),
as an eighth aspect, the measurement method according to the first aspect, wherein the a (adhesion target), the b (adhered substance), the c (external stimulation), and the d (medium) are a (substrate), b (contaminant), c (administration of a washing agent), and d (aqueous medium),
as a ninth aspect, the measurement method according to the first aspect, wherein the a (adhesion target), the b (adhered substance), the c (external stimulation), and the d (medium) are a (polymerizable monomers on a substrate), b (polymerizable monomers in the medium), c (administration of a catalyst into the medium), and d (solvent),
as a tenth aspect, the change measurement method according to the first aspect, wherein the a (adhesion target), the b (adhered substance), the c (external stimulation), and the d (medium) are a (coating film on a substrate), b (water), c (temperature change), and d (atmosphere adjustment gas),
as an eleventh aspect, the measurement method according to the first aspect, wherein the a (adhesion target), the b (adhered substance), the c (external stimulation), and the d (medium) are a (coating film on a substrate), b (detection target gas), c (temperature change), and d (atmosphere adjustment gas),
as a twelfth aspect, the measurement method according to the first aspect, wherein the a (adhesion target) is a silicon dioxide-containing layer, the b (adhered substance) is at least one oil selected from among a crude oil, a liquid hydrocarbon, and an edible oil, the c (external stimulation) is administration of an aqueous chemical solution for recovery containing silica particles and a surfactant, and the d (medium) is water or salt water, and wherein the change in the physical quantity is a change in a weight of the oil due to detachment from the silicon dioxide-containing layer,
as a thirteenth aspect, the measurement method according to the first aspect, wherein the a (adhesion target) is a silicon dioxide-containing layer, the b (adhered substance) is water in the silicon dioxide-containing layer, the c (external stimulation) is a temperature change, and the d (medium) is a humidity adjustment gas, and wherein the change in the physical quantity is a change in a weight of water due to desorption from the silicon dioxide-containing layer,
as a fourteenth aspect, the measurement method according to the first aspect, wherein the a (adhesion target) is a silicon dioxide-containing layer, the b (adhered substance) is water in a humidity adjustment gas, the c (external stimulation) is a temperature change, the d (medium) is a humidity adjustment gas, and the change in the physical quantity is a change in a weight of water due to adhesion to the silicon dioxide-containing layer,
as a fifteenth aspect, the measurement method according to the second aspect, wherein the chemical injection is performed by administering a solution containing a drug at 0.01 to 5 mL/min,
as a sixteenth aspect, the measurement method according to the first aspect, wherein the resonance frequency of the crystal resonator is in a range of 1 MHz to 100 MHz,
as a seventeenth aspect, a device for measuring the change in the physical quantity according to any one of the first aspect to the sixteenth aspect,
as an eighteenth aspect, a silica-containing chemical solution for oil recovery which satisfies a relationship of ΔF_{A}/ΔF_{B}=0.8 to 400 and ΔD_{A}/ΔD_{B}=0.8 to 100 when a detection unit including a sensor in which a silicon dioxide-containing layer corresponding to bedrock is formed on a sensor part having a diameter of 15 mm in which a gold electrode is wired on a crystal resonator, and an oil layer corresponding to a petroleum layer is adhered onto the silicon dioxide-containing layer at 0.5 to 10 μg/cm² is brought into contact with a fluid A containing, as components, salt water containing salts including sodium chloride at a concentration of 0.1 to 30% by mass and a silica-containing chemical solution for oil recovery or a fluid B containing the salt water but not containing the silica-containing chemical solution for oil recovery at a fluid flow rate of 0.01 to 5 mL/min at 25° C. and the sensor is resonated in a frequency range of 1 MHz to 100 MHz, wherein a value of ΔF_{A} indicates a maximum value of a frequency change value ΔF indicating a change in a weight of the oil layer, which is detected by the sensor upon contact with the fluid A, a value of ΔD_{A} indicates a local maximum value of an energy dissipation value ΔD indicating a change in an elastic modulus of the oil layer, which is detected by the sensor upon contact with the fluid A, a value of ΔF_{B} indicates a maximum value of a frequency change value ΔF indicating a change in a weight of the oil layer, which is detected by the sensor upon contact with the fluid B, and a value of ΔD_{B} indicates a local maximum value of an energy dissipation value ΔD indicating a change in an elastic modulus of the oil layer, which is detected by the sensor upon contact with the fluid B, and wherein the silica-containing chemical solution for oil recovery contains 0.0001 to 50% by mass of a silica and 0.001 to 40% by mass of a surfactant with respect to a mass of the silica, and
as a nineteenth aspect, a silica-containing chemical solution for oil recovery which satisfies a relationship of T_{C}>T_{A} when a detection unit including a sensor in which a silicon dioxide-containing layer corresponding to bedrock is formed on a sensor part having a diameter of 15 mm in which a gold electrode is wired on a crystal resonator, and an oil layer corresponding to a petroleum layer is adhered onto the silicon dioxide-containing layer at 0.5 to 10 μg/cm² is brought into contact with a fluid A containing, as components, salt water containing salts including sodium chloride at a concentration of 0.1 to 30% by mass and a silica-containing chemical solution for oil recovery or a fluid C containing the salt water and a silica-free chemical solution for oil recovery at a fluid flow rate of 0.01 to 5 mL/min at 25° C., and the sensor is resonated in a frequency range of 1 MHz to 100 MHz, wherein a value of T_{A} is a time from when a change in an energy dissipation value ΔD_{A} indicating a change in an elastic modulus of the oil layer starts until the energy dissipation value ΔD_{A} reaches a maximum, which is detected by the sensor upon contact with the fluid A, and a value of T_{C} is a time from when a change in an energy dissipation value ΔD_{C} indicating a change in an elastic modulus of the oil layer (=ΔD_{B} value) starts until the energy dissipation value ΔD_{C} becomes a maximum, which is detected by the sensor upon contact with the fluid C.

### Effects of the Invention

There is a need for a method of quantitatively expressing compatibility such as affinity and interaction between substances (here, an adhesion target and an adhered substance) using a numerical value. The compatibility between these substances also changes depending on what kind of medium the target substances are present in, for example, whether they are in a gas medium or a liquid medium. In addition, the change in the compatibility between substances is thought to be accelerated when external stimulation acts as a catalyst. Here, examples of external stimulation include chemical injection and a temperature change.

The compatibility between substances can be parameterized according to the change in the physical quantity such as a weight or elastic modulus through the state change. The change in the physical quantity is a change in the elastic modulus of the adhered substance on the adhesion target, a change in the weight (amount of detachment or the amount of adhesion) of the adhered substance or the like. By measuring these, it is possible to determine the amount of change or the occurrence of change (state change) itself.

The relationship between substances includes, for example, the relationship between bedrock and crude oil, the relationship between a substrate and contaminants, the relationship between polymerizable monomers, the relationship between adsorption and desorption of water on a coating film, and the relationship of gas adsorption on a coating film.

When the physical quantities (weight and elastic modulus) related to the adhered substance are measured, it is possible to observe the elastic state of the adhered substance, and the adsorption/desorption (adhesion/detachment) state of the adhered substance, and further observe the contamination/cleaning state of the substances, the wet/dry state, and the like therefrom.

In the present invention, the QCM method can be used to measure the interaction (adsorption onto the surface and desorption from the surface) that occurs between the substance (film) on the surface of the sensor and the substance present in the medium on the surface. When the frequency obtained when the sensor is caused to resonate is continuously measured, it is possible to measure the coefficient (ΔF value) of frequency change. In addition, when the sensor is caused to resonate and resonance is then instantaneously stopped, it is possible to observe film elasticity and structural changes (hardness and softness) as the energy dissipation value (ΔD value), which is a value at which vibration gradually decreases.

In the present invention, using these measurement results, it is found that the change (state change) in the relationship between the adhesion target and the adhered substance in the medium due to external stimulation can be measured as a change in the physical quantity.

### BRIEF DESCRIPTION OF THE DRAWINGS

FIG. 1 is a diagram showing the measurement results of a frequency change value (ΔF value) indicating a change in the film weight (change in the weight of an oil layer) detected by a QCM sensor in Example 1 and Example 2.

FIG. 2 is a diagram showing the measurement results of an energy dissipation value (ΔD value) indicating a change in the film elastic modulus (change in the elastic modulus of an oil layer) detected by the QCM sensor in Example 1 and Example 2.

FIG. 3 is a diagram showing the measurement results of a frequency change value (ΔF value) indicating a change in the film weight (change in the weight of an oil layer) detected by the QCM sensor in Example 3 and Example 4.

FIG. 4 is a diagram showing the measurement results of an energy dissipation value (ΔD value) indicating a change in the film elastic modulus (change in the elastic modulus of an oil layer) detected by the QCM sensor in Example 3 and Example 4.

FIG. 5 is a diagram showing the measurement results of a frequency change value (ΔF value) indicating a change in the film weight (change in the weight of an oil layer) detected by the QCM sensor in Comparative Example 1.

FIG. 6 is a diagram showing the measurement results of an energy dissipation value (ΔD value) indicating a change in the film elastic modulus (change in the elastic modulus of an oil layer) detected by the QCM sensor in Comparative Example 1.

FIG. 7 is a diagram showing the measurement results of a frequency change value (ΔF value) indicating a change in the film weight (change in the weight of an oil layer) detected by the QCM sensor in Example 5.

FIG. 8 is a diagram showing the measurement results of an energy dissipation value (ΔD value) indicating a change in the film elastic modulus (change in the elastic modulus of an oil layer) detected by the QCM sensor in Example 5.

FIG. 9 is a diagram showing the measurement results of a frequency change value (ΔF value) indicating a change in the film weight (change in the weight of an oil layer) detected by the QCM sensor in Example 6.

FIG. 10 is a diagram showing the measurement results of an energy dissipation value (ΔD value) indicating a change in the film elastic modulus (change in the elastic modulus of an oil layer) detected by the QCM sensor in Example 6.

FIG. 11 is a diagram showing the measurement results of a frequency change value (ΔF value) indicating a change in the film weight (change in the weight of an oil layer) detected by the QCM sensor in Example 7.

FIG. 12 is a diagram showing the measurement results of an energy dissipation value (ΔD value) indicating a change in the film elastic modulus (change in the elastic modulus of an oil layer) detected by the QCM sensor in Example 7.

FIG. 13 is a diagram showing the measurement results of a frequency change value (ΔF value) indicating a change in the film weight (change in the weight of an oil layer) detected by the QCM sensor in Example 8.

FIG. 14 is a diagram showing the measurement results of an energy dissipation value (ΔD value) indicating a change in the film elastic modulus (change in the elastic modulus of an oil layer) detected by the QCM sensor in Example 8.

FIG. 15 is a diagram showing the measurement results of a frequency change value (ΔF value) indicating a change in the film weight (change in the weight of an oil layer) detected by the QCM sensor in Example 9.

FIG. 16 is a diagram showing the measurement results of an energy dissipation value (ΔD value) indicating a change in the film elastic modulus (change in the elastic modulus of an oil layer) detected by the QCM sensor in Example 9.

FIG. 17 is a diagram showing the measurement results of a frequency change value (ΔF value) indicating a change in the film weight (change in the weight of an oil layer) detected by the QCM sensor in Example 10.

FIG. 18 is a diagram showing the measurement results of an energy dissipation value (ΔD value) indicating a change in the film elastic modulus (change in the elastic modulus of an oil layer) detected by the QCM sensor in Example 10.

FIG. 19 is a diagram showing the measurement results of a frequency change value (ΔF value) indicating a change in the film weight (change in the weight of an oil layer) detected by the QCM sensor in Example 11.

FIG. 20 is a diagram showing the measurement results of an energy dissipation value (ΔD value) indicating a change in the film elastic modulus (change in the elastic modulus of an oil layer) detected by the QCM sensor in Example 11.

FIG. 21 is a diagram showing the measurement results of a frequency change value (ΔF value) indicating a change in the film weight (change in the weight of an oil layer) detected by the QCM sensor in Comparative Example 2.

FIG. 22 is a diagram showing the measurement results of an energy dissipation value (ΔD value) indicating a change in the film elastic modulus (change in the elastic modulus of an oil layer) detected by the QCM sensor in Comparative Example 2.

### MODES FOR CARRYING OUT THE INVENTION

The present invention is a measurement method using a QCM sensor, and specifically, a method includes causing a detection unit including a sensor including a crystal resonator in which an adhesion target and an adhered substance are laminated to resonate in a medium, measuring the amount of change using a change in a resonance frequency of the crystal resonator caused by external stimulation to the detection unit, and thus measuring a change in a physical quantity of the adhered substance on the adhesion target. When the change in the physical quantity of the adhered substance is measured, it is possible to observe a change in a state such as dryness and wetness, for example, as will be described below, when the adhered substance is water.

The detection unit has a structure in which an adhesion target and an adhered substance thereon are applied onto a sensor including a crystal resonator in an overlapping manner. For example, the detection unit includes a sensor part in which an electrode is laminated on the surface of the crystal resonator, and a laminated part in which an adhesion target and an adhered substance on the surface are laminated on the sensor, and since the resonance frequency of the crystal resonator changes due to adsorption/desorption (or adhesion/detachment) of the adhered substance, the laminated part can be regarded as a sensing part.

In addition, the crystal resonator can be used in a range in which the resonance frequency is 100 Hz to 100 MHz, typically 1 MHz to 100 MHz.

In the present invention, external stimulation refers to chemical injection or temperature change. Chemical injection and temperature changes not only change the compatibility such as affinity and interaction between substances (an adhesion target and an adhered substance) but also have the effect of accelerating or decelerating the change. Chemical injection includes injection of a drug into a medium and bringing the drug into contact with the adhered substance. The temperature change can be dealt with by raising or lowering the temperature of the adhesion target and the adhered substance from the outside using a heater, a cooler and the like, or by changing the temperature of the medium itself that is brought into contact with the adhesion target and the adhered substance.

When a substance adheres to the surface of the crystal resonator constituting the QCM sensor or an adhered substance is peeled off, the weight and elastic modulus of the crystal resonator part change. This causes a change in the resonance frequency of the crystal resonator. In the present invention, based on this change in resonance frequency, changes in weight and elastic modulus are measured, and state changes such as adhesion/detachment or adsorption/desorption of substances are observed through changes in these physical quantities.

The change in the physical quantity refers to, for example, a change in the elastic modulus of the adhered substance on the surface of the adhesion target. Regarding the adhesion target and the adhered substance, when a change in the elastic modulus of the adhered substance due to external stimulation in the medium is measured, it is possible to observe a change in the elastic state of the adhered substance.

The change in the physical quantity is, for example, a change in the elastic modulus of the laminated part composed of the adhesion target and the adhered substance due to detachment of the adhered substance on the surface of the adhesion target. The elastic state of the laminated part differs depending on whether the adhered substance is completely detached or partially detached.

The change in the physical quantity refers to, for example, a change in the weight of the adhered substance. This occurs due to detachment of the adhered substance from the surface of the adhesion target or adhesion of the adhered substance to the surface of the adhesion target. The resonance frequency changes depending on the amount of change in the weight of the adhered substance.

In the measurement method of the present invention, the adhesion target and the adhered substance are present in a medium, and the medium is a gas or a liquid. Examples of gases include an atmosphere adjustment gas and a humidity adjustment gas, and specific examples thereof include air, an inert gas, and water vapor. The humidity adjustment gas is a gas whose relative humidity (RH) is adjusted to a desired % (0% to 100%). In addition, examples of liquids include pure water, an aqueous solution, ionic water, salt water, and an organic solvent.

In the present invention, in measurement of a change in a state of compatibility such as affinity and interaction between substances performed using the QCM sensor, the relationship between a (adhesion target), b (adhered substance), c (external stimulation) and d (medium) is as follows.

For example, the relationship between a (adhesion target), b (adhered substance), c (external stimulation) and d (medium) is as follows: a (bedrock), b (oil), c (administration of a chemical solution for recovery) and d (salt water).

For example, this is considered as a situation assuming recovery of oil (crude oil) by injecting a chemical solution for recovery, and the crude oil recovery rate changes depending on components of a chemical solution for recovery that is an external stimulus. In addition, in this case, the effectiveness of the drug used in salt water is also influenced by the concentration of the salt water.

For example, the relationship between a (adhesion target), b (adhered substance), c (external stimulation) and d (medium) is as follows: a (substrate), b (contaminant), c (administration of a washing agent) and d (aqueous medium).

For example, this is a situation assuming washing of contaminants on the substrate, and the desorption rate of contaminants on the substrate changes depending on components (types) of a detergent that is an external stimulus.

The substrate of the present invention is, for example, an electrode on the surface of the crystal resonator, and may include, for example, a film or layer such as a silicon dioxide-containing layer formed on the electrode.

For example, the relationship between a (adhesion target), b (adhered substance), c (external stimulation) and d (medium) is as follows: a (polymerizable monomers on the substrate), b (polymerizable monomers in the medium), c (administration of a catalyst in the medium) and d (solvent).

This is a situation assuming polymerization of polymerizable monomers on the substrate and polymerizable monomers in the medium, and when a polymer is formed, the polymerization rate changes due to the catalyst that is an external stimulus. The catalyst is not particularly limited as long as it is used to change the polymerization rate of the polymer.

For example, the relationship between a (adhesion target), b (adhered substance), c (external stimulation) and d (medium) is as follows: a (coating film on a substrate), b (water), c (temperature change) and d (atmosphere adjustment gas).

This is considered as a situation assuming a change in the wet/dry state of the coating film on the substrate. Due to a temperature change that is external stimulation, the amount of atmospheric water adhered to the coating film on the substrate and the amount of water desorbed from the coating film change.

More specifically, the a (adhesion target) can be, for example, a silicon dioxide-containing layer formed on the electrode on the surface of the crystal resonator, the b (adhered substance) can be water in the silica-containing film, the c (external stimulation) can be a temperature change, and the d (medium) can be a humidity adjustment gas. Examples of electrodes include a gold electrode. In this aspect, the change in the physical quantity is a change in the weight of water due to desorption from the silicon dioxide-containing layer.

Here, for example, the a (adhesion target) can be a silicon dioxide-containing layer formed on the electrode on the surface of the crystal resonator, the b (adhered substance) can be water in a humidity adjustment gas to be described below, the c (external stimulation) can be a temperature change, and the d (medium) can be a humidity adjustment gas. Examples of electrodes include a gold electrode. In this aspect, the change in the physical quantity is a change in the weight of water due to adhesion to the silicon dioxide-containing layer.

For example, the relationship between a (adhesion target), b (adhered substance), c (external stimulation) and d (medium) is as follows: a (coating film on a substrate), b (detection target gas), c (temperature change) and d (atmosphere adjustment gas).

This is considered as a situation assuming a sensor that detects the presence of adsorption of a harmful gas and the like onto the coating film on the substrate, and the amount of adsorption.

Hereinafter, a specific example in which the a (adhesion target) is a silicon dioxide-containing layer corresponding to bedrock, the b (adhered substance) is an oil such as a crude oil, a liquid hydrocarbon corresponding to a crude oil or an edible oil, the c (external stimulation) is administration of an oil recovery aqueous chemical solution containing silica particles and a surfactant, and the d (medium) is water or salt water in which the detection unit is immersed will be shown. In this aspect, the change in the physical quantity is a change in the weight of the oil due to detachment from the silicon dioxide-containing layer.

As a (adhesion target), one in which a silicon dioxide-containing layer corresponding to bedrock is evaporated on a sensor part having a diameter of 15 mm in which a gold electrode is wired on a crystal resonator is prepared.

As b (adhered substance), for example, a liquid hydrocarbon corresponding to a crude oil is used, and an oil layer (also referred to as an oil film) corresponding to a petroleum layer is coated on the a (adhesion target). As described above, examples of oil layers include a crude oil layer, a layer of a C₈₋₂₀ liquid hydrocarbon, and an edible oil layer.

In a physical quantity measurement device, a detection unit including a sensor can be formed by a combination of a (adhesion target) and b (adhered substance).

The detection unit including a sensor is brought into contact with a fluid containing salt water and a silica-containing chemical solution for oil recovery, the sensor is caused to resonate, and a frequency change value (ΔF value) indicating a change in the film weight and an energy dissipation value (ΔD value) indicating a change in the film elastic modulus are measured. Regarding these values, the ΔF value increases by a factor of 0.8 to 400, 1.2 to 400, 20 to 400, or 100 to 400, and the ΔD value increases by a factor of 0.8 to 100, 1 to 100, or 5 to 100 compared to those in the case in which the silica-containing chemical solution for oil recovery is not included. This silica-containing chemical solution for oil recovery is also an object of the present invention.

Here, a case in which the ΔF value and the ΔD value are measured by performing bringing into contact with the fluid containing salt water and a silica-containing chemical solution for oil recovery is shown. However, in addition to the above case, measurement can be performed by bringing c (washing agent), d (aqueous medium) and a washing agent into contact with the detection unit of a (substrate) and b (contaminant), and measurement can also be performed by bringing c (catalyst into the medium) and d (solvent) into contact with the detection unit of a (polymerizable monomers on the substrate) and b (polymerizable monomers in the medium). In addition, measurement can also be performed by causing c (temperature change) in the detection unit of a (coating film on a substrate) and b (water) and bringing d (atmospheric gas) into contact with the detection unit, and measurement can also be performed by causing c (temperature change) in the detection unit of a (coating film on a substrate) and b (detection target gas), and bringing d (atmospheric gas) into contact with the detection unit. In addition, measurement can also be performed by causing c (temperature change) in the detection unit of a (silicon dioxide-containing layer) and b (water in the silicon dioxide-containing layer) and bringing d (humidity adjustment gas) into contact with the detection unit. Measurement can also be performed by causing c (temperature change) in the detection unit of a (silicon dioxide-containing layer) and b (water in the humidity adjustment gas), and bringing d (humidity adjustment gas) into contact with the detection unit.

More specifically, a detection unit including a sensor in which a silicon dioxide-containing layer corresponding to bedrock is formed on a sensor part having a diameter of 15 mm in which a gold electrode is wired on a crystal resonator, and an oil layer corresponding to a petroleum layer is adhered thereonto at 0.5 to 10 μg/cm², 0.5 to 7 μg/cm², or 0.5 to 5 μg/cm² is prepared, and a fluid A containing, as components, salt water containing salts including sodium chloride at a concentration of 0.1 to 30% by mass and a silica-containing chemical solution for oil recovery or a fluid B containing the salt water but not containing the silica-containing chemical solution for oil recovery is brought into contact with the detection unit at a fluid flow rate of 0.01 to 5 mL/min. Then, the sensor (crystal resonator) is caused to resonate in a frequency range of 100 Hz to 100 MHz, typically 1 MHz to 100 MHz. The silica-containing chemical solution for oil recovery contains silica at a concentration of 0.0001 to 50% by mass, and a surfactant at a mass ratio of 0.001 to 40% by mass relative to the silica.

Here, the maximum value of the frequency change value ΔF indicating a change in the weight of the oil layer is the ΔF_{A} value and the local maximum value of the energy dissipation value ΔD indicating a change in the elastic modulus of the oil layer is the ΔD_{A} value, which are detected by the sensor upon contact with the fluid A. Similarly, the maximum value of the frequency change value ΔF indicating a change in the weight of the oil layer is ΔF_{B} value, and the local maximum value of the energy dissipation value ΔD indicating a change in the elastic modulus of the oil layer is ΔD_{B} value, which are detected by the sensor upon contact with the fluid B.

Here, in the silica-containing chemical solution for oil recovery of the present invention, the relationships of ΔF_{A}/ΔF_{B}=0.8 to 400, 1.2 to 400, 20 to 400, or 100 to 400 and ΔD_{A}/ΔD_{B}=0.8 to 100, 1 to 100, or 5 to 100 are satisfied.

In addition, the detection unit including a sensor is brought into contact with a fluid containing salt water and a silica-containing chemical solution for oil recovery, the sensor is caused to resonate, and the time from when a change in the energy dissipation value (ΔD value) indicating a change in the film elastic modulus starts until the value reaches a maximum is measured. Since this value is smaller than when it is brought into contact with a fluid containing salt water and a silica-free chemical solution for oil recovery, the time is shortened. The silica-containing chemical solution for oil recovery is also an object of the present invention.

More specifically, a detection unit including a sensor in which a silicon dioxide-containing layer corresponding to bedrock is formed on a sensor part having a diameter of 15 mm in which a gold electrode is wired on a crystal resonator, and an oil layer corresponding to a petroleum layer is adhered thereonto at 0.5 to 10 μg/cm², 0.5 to 7 μg/cm², or 0.5 to 5 μg/cm² is prepared. A fluid A containing, as components, salt water containing salts including sodium chloride at a concentration of 0.1 to 30% by mass and a silica-containing chemical solution for oil recovery or a fluid C containing the salt water and a silica-free chemical solution for oil recovery is brought into contact with the detection unit at a flow rate of 0.01 to 5 mL/min. Then, the sensor is caused to resonate in a frequency range of 100 Hz to 100 MHz, typically 1 MHz to 100 MHz.

Here, the time from when a change in the energy dissipation value ΔD indicating a change in the elastic modulus of the oil layer starts until the value reaches a maximum, which is detected by the sensor upon contact with the fluid A, is the T_{A} value, and similarly, the time from when a change in the energy dissipation value ΔD indicating a change in the elastic modulus of the oil layer starts until the value reaches a maximum, which is detected by the sensor upon contact with the fluid C, is the T_{C} value.

Here, in the silica-containing chemical solution for oil recovery of the present invention, the relationship of T_{C}>T_{A} is satisfied.

The sensor uses a crystal resonator having a diameter of 15 mm, and this can be used for measurement for resonating at, for example, a resonance frequency of about 25 MHz.

In measurement using the QCM sensor of the present invention, the amount of change in film weight (for example, a change in the weight of the oil layer) can be measured based on the frequency change value (ΔF value).

In the measurement, if the ΔF value when the QCM sensor is brought into contact with a blank solution containing no drug (for example, only salt water) is zero, the ΔF value changes negatively when an oil is adsorbed onto the film and the ΔF value changes positively when an oil is peeled off the film.

In addition, in measurement using the QCM sensor, the amount of change in film elastic modulus (for example, a change in the elastic modulus of the oil layer) can be measured based on the energy dissipation value (ΔD value).

In the measurement, if the ΔD value when the QCM sensor is brought into contact with a blank solution containing no drug (for example, only salt water) is zero, a negative change in ΔD reflects the state in which the surrounding area of the film becomes hard and a positive change in ΔD reflects the state in which the surrounding area of the film becomes soft.

The chemical solution for oil recovery according to the present invention (hereinafter also referred to as a chemical solution) can contain, as silica particles, for example, an aqueous silica sol having an average particle diameter of 3 to 200 nm, and a surfactant.

The aqueous silica sol can be used in a pH range of 2 to 12.

The aqueous silica sol is a colloidal dispersion system in which an aqueous solvent is used as a dispersion medium, and colloidal silica particles are used as dispersoids, and it can be produced by a known method using water glass (sodium silicate aqueous solution) as a raw material.

The average particle diameter of the aqueous silica sol refers to the average particle diameter of colloidal silica particles that are dispersoids.

In the present invention, unless otherwise specified, the average particle diameter of the aqueous silica sol (colloidal silica particles) refers to the specific surface area diameter measured by the nitrogen adsorption method (BET method) or the Sears method particle diameter.

In the present invention, the average particle diameter of the aqueous silica sol (colloidal silica particles) determined by the nitrogen adsorption method (BET method) or the Sears method can be 3 to 200 nm, 3 to 150 nm, 3 to 100 nm, or 3 to 30 nm.

In addition, in measurement of silica particles in a silica sol in a chemical solution by a dynamic light scattering method, the average particle diameter (DLS average particle diameter) can be measured, and the dispersion state thereof (whether silica particles are in a dispersion state or in an aggregated state) can be determined.

The DLS average particle diameter refers to an average value of secondary particle diameters (dispersed particle diameter). It is said that the diameter of DLS average particles that are completely dispersed is about twice the average particle diameter (which indicates a specific surface area diameter obtained by measurement by the nitrogen adsorption method (BET method) or the Sears method, and an average value of primary particle diameters). Here, as the DLS average particle diameter increases, it can be determined that the silica particles in the medium (aqueous silica sol or chemical solution) are in an aggregated state.

In the chemical solution according to the present invention, the average particle diameter of silica particles determined by the DLS method can be 3 to 200 nm, 3 to 150 nm, 3 to 100 nm, or 3 to 30 nm.

Aqueous silica sols include an alkaline aqueous silica sol and an acidic aqueous silica sol. Both of these can be used, and an acidic aqueous silica sol can be used preferably.

Examples of commercially available acidic aqueous silica sols include Snowtex (product name) ST-OXS, ST-OS, ST-O, ST-O-40, ST-OL, ST-OYL, and ST-OZL-35 (all commercially available from Nissan Chemical Corporation). An aqueous silica sol (product name, Snowtex ST-O, commercially available from Nissan Chemical Corporation) has an average particle diameter (BET method) of 10 to 11 nm and a DLS average particle diameter of 15 to 20 nm.

In the chemical solution for crude oil recovery according to the present invention, a silane compound to be described below may be bonded to a part of the surface of the silica particles in the aqueous silica sol. In addition, the chemical solution for crude oil recovery according to the present invention may contain a silane compound.

The silane compound is, for example, a silane coupling agent having at least one group selected from the group consisting of a vinyl group, an ether group, an epoxy group, a styryl group, a methacrylic group, an acrylic group, an amino group and an isocyanurate group as an organic functional group. In addition to the above examples, alkoxysilane, silazane, siloxane and the like may be exemplified as preferable silane compounds.

Examples of silane coupling agents having a vinyl group or styryl group include vinyltrichlorosilane, vinyltrimethoxysilane, vinyltriethoxysilane, vinyltris(2-methoxyethoxy)silane, vinylmethyldimethoxysilane, vinyltriacetoxysilane, allyltrichlorosilane, allyltrimethoxysilane, allyltriethoxysilane, and p-styryltrimethoxysilane.

Examples of silane coupling agents having an epoxy group include 3-glycidoxypropyltrimethoxysilane, 3-glycidoxypropyltriethoxysilane, 3-glycidoxypropylmethyldimethoxysilane, 3-glycidoxypropylmethyldiethoxysilane, 3-glycidoxypropyltriethoxysilane, 2-(3,4-epoxycyclohexyl)propyltrimethoxysilane, 2-(3,4-epoxycyclohexyl)propyltriethoxysilane, 2-(3,4-epoxycyclohexyl)ethyltrimethoxysilane, 2-(3,4-epoxycyclohexyl)ethyltriethoxysilane, 2-(3,4-epoxycyclohexyl)methyltrimethoxysilane, 2-(3,4-epoxycyclohexyl)methyltriethoxysilane, [(3-ethyl-3-oxetanyl)methoxy]propyltrimethoxysilane, and [(3-ethyl-3-oxetanyl)methoxy]propyltriethoxysilane.

Examples of silane coupling agents having a methacrylic group (methacryloyl group) or acrylic group (acryloyl group) include 3-methacryloyloxypropyltrimethoxysilane, 3-methacryloyloxypropyltriethoxysilane, 3-methacryloyloxypropylmethyldimethoxysilane, 3-methacryloyloxypropylmethyldiethoxysilane, 3-acryloyloxypropyltrimethoxysilane, and 3-acryloyloxypropyltriethoxysilane.

Examples of silane coupling agents having an amino group include N-2-(aminoethyl)-3-aminopropylmethyldimethoxysilane, N-2-(aminoethyl)-3-aminopropyltrimethoxysilane, 3-aminopropyltrichlorosilane, 3-aminopropyltrimethoxysilane, 3-aminopropyltriethoxysilane, 3-aminopropylmethyldimethoxysilane, 3-aminopropylmethyldiethoxysilane, 3-triethoxysilyl-N-(1,3-dimethyl-butylidene) propylamine, N-phenyl-3-aminopropyltrimethoxysilane, and N-phenyl-3-aminopropyltriethoxysilane.

Examples of silane coupling agents having an isocyanurate group include tris-(3-trimethoxysilylpropyl)isocyanurate and tris-(3-triethoxysilylpropyl)isocyanurate, and examples of silane coupling agents having an isocyanate group include 3-isocyanatepropyltriethoxysilane and 3-isocyanatepropyltrimethoxysilane.

In addition, alkoxysilanes such as methyltrimethoxysilane, methyltriethoxysilane, dimethyldimethoxysilane, dimethyldiethoxysilane, trimethylmethoxysilane, ethyltrimethoxysilane, tetraethoxysilane, n-propyltriethoxysilane, isobutyltrimethoxysilane, isobutyltriethoxy silane, phenyltrimethoxy silane, phenyltriethoxy silane, diphenyldimethoxysilane, diphenyldiethoxysilane, n-propyltrimethoxysilane, n-hexyltrimethoxysilane, n-hexyltriethoxysilane, cyclohexylmethyldimethoxysilane, n-octyltriethoxysilane, and n-decyltrimethoxysilane; silazanes such as hexamethyldisilazane; and siloxanes such as methylmethoxy siloxane and dimethyl phenylmethoxy siloxane can also be used.

Among these silane compounds, more preferably, an amphipathic silane coupling agent having an ether group, an epoxy group, a methacrylic group, or an acrylic group as an organic functional group is preferable.

Examples thereof include 3-glycidoxypropyltrimethoxysilane, 3-glycidoxypropylmethyldimethoxysilane, 3-glycidoxypropylmethyldiethoxysilane, 3-glycidoxypropyltriethoxysilane, 2-(3,4-epoxycyclohexyl)ethyltrimethoxysilane, 3-methacryloyloxypropyltrimethoxysilane, 3-methacryloyloxypropylmethyldimethoxysilane, 3-methacryloyloxypropyltriethoxysilane, 3-methacryloyloxypropylmethyldiethoxysilane, and 3-acryloyloxypropyltrimethoxysilane.

In the chemical solution for oil recovery according to the present invention, the silane compound can be added at a ratio such that, with respect to the silica solid content in the aqueous silica sol, that is, silica particles, the mass ratio of the silane compound/the aqueous silica sol (silica:SiO₂)=0.1 to 10.0. In addition, for example, it can be added at a ratio such that the mass ratio is 0.1 to 5.0.

When the mass ratio of the silane compound with respect to the silica particles in the aqueous silica sol is set to be within the above range, it can be expected to improve salt resistance of the chemical solution at high temperatures. However, if the mass ratio is less than 0.1, there is a risk of high-temperature salt resistance of the chemical solution deteriorating, and if the mass ratio is more than 10.0, that is, a large amount of the silane compound is added, no further improvement in effect is expected.

In addition, as described above, in the chemical solution for oil recovery according to the present invention, a silane compound to be described below may be bonded to a part of the surface of the silica particles in the aqueous silica sol. That is, the aqueous silica sol may be subjected to surface treatment with a silane compound. Here, “a silane compound is bonded to at least a part of the surface of the silica particle” refers to a form in which a silane compound is bonded to at least a part of the surface of the silica particle, and includes a form in which the silane compound covers the entire surface of the silica particle and a form in which the silane compound covers a part of the surface of the silica particle.

When silica particles with a silane compound bonded to at least a part of their surfaces, for example, silica particles whose surface is coated with a silane compound, are used, it is possible to further improve the high-temperature salt resistance of the chemical solution for oil recovery.

Therefore, in a preferable aspect, the chemical solution for oil recovery according to the present invention includes silica particles in which at least a part of the silane compound is bonded to at least a part of the surface of the silica particles in the aqueous silica sol.

Silica particles in which at least a part of the silane compound is bonded to the surface of at least some thereof (hereinafter also referred to as silica particles subjected to surface treatment with a silane compound) can be obtained by adding a silane compound to an aqueous silica sol at a ratio such that the mass ratio of the silane compound with respect to silica particles (silica solid content) in the aqueous silica sol is 0.1 to 10.0 and then performing a heat treatment, for example, at 50 to 100° C. for 1 hour to 20 hours.

In this case, it is preferable that the amount of surface treatment with the silane compound, that is, the silane compound bonded to the surface of silica particles, be, for example, about 0.1 to 12 pieces per 1 nm² of the surface of the silica particles.

If the heat treatment temperature is lower than 50° C., the rate of partial hydrolysis of hydrolyzable groups (alkoxy groups, etc.) of the silane compound is slow, and the surface treatment efficiency deteriorates. On the other hand, if the temperature is higher than 100° C., this is not preferable because a dry silica gel is not formed.

In addition, if the heat treatment time is shorter than 1 hour, the partial hydrolysis reaction of the silane compound becomes insufficient, and if the heat treatment time is 20 hours or longer, the partial hydrolysis reaction of the silane compound becomes almost saturated, and thus there is no need to increase the heating time any longer.

Examples of surfactants added to the chemical solution for oil recovery according to the present invention include anionic surfactants, cationic surfactants, nonionic surfactants, and amphoteric surfactants.

For example, a silica sol subjected to surface treatment with an anionic functional group such as an epoxy group-containing silane can be used in combination with surfactants including anionic surfactants.

In addition, for example, a silica sol subjected to surface treatment with a cationic functional group such as an amino group-containing silane can be used in combination with surfactants including nonionic surfactants and/or cationic surfactants.

### Anionic Surfactant

In the chemical solution for oil recovery of the present invention, examples of anionic surfactants include sodium salts and potassium salts of fatty acids, alkylbenzene sulfonate, higher alcohol sulfate ester salts, polyoxyethylene alkyl ether sulfate, α-sulfo fatty acid ester, α-olefin sulfonate, monoalkyl phosphate ester salts, and alkanesulfonate.

Examples of alkylbenzene sulfonates include sodium salts, potassium salts and lithium salts, and C₁₀₋₁₆ sodium alkylbenzenesulfonate, C₁₀₋₁₆ potassium alkylbenzenesulfonate, and sodium alkylnaphthalene sulfonate may be exemplified.

Examples of higher alcohol sulfate ester salts include C₁₂ sodium dodecyl sulfates (sodium lauryl sulfate), triethanolamine lauryl sulfate, and triethanolammonium lauryl sulfate.

Examples of polyoxyethylene alkyl ether sulfates include sodium polyoxyethylene styrenated phenyl ether sulfate, ammonium polyoxyethylene styrenated phenyl ether sulfate, sodium polyoxyethylene decyl ether sulfate, ammonium polyoxyethylene decyl ether sulfate, sodium polyoxyethylene lauryl ether sulfate, ammonium polyoxyethylene lauryl ether sulfate, sodium polyoxyethylene tridecyl ether sulfate, and sodium polyoxyethylene oleyl cetyl ether sulfate.

Examples of α-olefin sulfonates include sodium α-olefin sulfonate.

Examples of alkanesulfonates include sodium 2-ethylhexyl sulfate.

### Cationic Surfactant

Examples of cationic surfactants in the chemical solution for oil recovery of the present invention include alkyltrimethylammonium salts, dialkyldimethylammonium salts, alkyldimethylbenzylammonium salts, and amine salt agents.

The alkyltrimethylammonium salt is a quaternary ammonium salt, and has chloride ions or bromine ions as counter ions. Examples thereof include dodecyltrimethylammonium chloride, cetyltrimethylammonium chloride, coco alkyltrimethylammonium chloride, and alkyl(C₁₆₋₁₈)trimethylammonium chloride.

The dialkyldimethylammonium salt has two lipophilic main chains and two methyl groups. Examples thereof include didecyldimethylammonium chloride, dicoco alkyldimethylammonium chloride, di(hardened beef tallow alkyl)dimethylammonium chloride, and dialkyl (C₁₄₋₁₈) dimethylammonium chloride.

The alkyldimethylbenzylammonium salt is a quaternary ammonium salt having one lipophilic main chain, two methyl groups, and a benzyl group (benzalkonium chloride), and examples thereof include alkyl(C₈₋₁₈) dimethylbenzylammonium chloride.

Examples of amine salt agents include those in which hydrogen atoms of ammonia are replaced with one or more hydrocarbon groups such as N-methylbishydroxyethylamine fatty acid ester hydrochloride.

### Amphoteric Surfactant

In the chemical solution for oil recovery of the present invention, examples of amphoteric surfactants include N-alkyl-β-alanine-type alkylamino fatty acid salts, alkylcarboxybetaine-type alkylbetaine, and N,N-dimethyldodecylamine oxide-type alkylamine oxide.

Examples of these include lauryl betaine, stearyl betaine, 2-akyl-N-carboxymethyl-N-hydroxyethylimidazolinium betaine, and lauryldimethylamine oxide.

### Nonionic Surfactant

In the chemical solution for oil recovery of the present invention, the nonionic surfactant is selected from among polyoxyethylene alkyl ether, polyoxyethylene alkyl phenyl ether, alkyl glucoside, polyoxyethylene fatty acid ester, sucrose fatty acid ester, sorbitan fatty acid ester, polyoxyethylene sorbitan fatty acid ester, and fatty acid alkanolamide. Examples of polyoxyethylene alkyl ethers include polyoxyethylene dodecyl ether (polyoxyethylene lauryl ether), polyoxyalkylene lauryl ether, polyoxyethylene tridecyl ether, polyoxyalkylene tridecyl ether, polyoxyethylene myristyl ether, polyoxyethylene cetyl ether, polyoxyethylene oleyl ether, polyoxyethylene stearyl ether, polyoxyethylene behenyl ether, polyoxyethylene-2-ethylhexyl ether, and polyoxyethylene isodecyl ether.

Examples of polyoxyethylene alkyl phenyl ethers include polyoxyethylene styrenated phenyl ether, polyoxyethylene nonylphenyl ether, polyoxyethylene distyrenated phenyl ether, and polyoxyethylene tribenzylphenyl ether.

Examples of alkyl glucosides include decyl glucoside and lauryl glucoside.

Examples of polyoxyethylene fatty acid esters include polyoxyethylene monolaurate, polyoxyethylene monostearate, polyoxyethylene monooleate, polyethylene glycol distearate, polyethylene glycol diolate, and polypropylene glycol diolate.

Examples of sorbitan fatty acid esters include sorbitan monocaprylate, sorbitan monolaurate, sorbitan monomyristate, sorbitan monopalmitate, sorbitan monostearate, sorbitan distearate, sorbitan tristearate, sorbitan monooleate, sorbitan triolate, sorbitan monosesquiolate, and ethylene oxide adducts thereof.

Examples of polyoxyethylene sorbitan fatty acid esters include polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate, and polyoxyethylene sorbitan triisostearate.

In addition, examples of fatty acid alkanolamides include coconut oil fatty acid diethanolamide, beef tallow fatty acid diethanolamide, lauric acid diethanolamide, and oleic acid diethanolamide.

In addition, polyoxyalkyl ethers such as polyoxyethylene polyoxypropylene glycol and polyoxyethylene fatty acid ester, polyoxyalkyl glycol, polyoxyethylene hydrogenated castor oil ether, sorbitan fatty acid ester alkyl ether, alkyl polyglucoside, sorbitan monooleate, sucrose fatty acid ester and the like can also be used.

### EXAMPLES

Hereinafter, the present invention will be described in more detail with reference to synthesis examples, examples, and comparative examples, but the present invention is not limited to these examples.

### Measurement Device

In the examples, a QSence Analyzer (commercially available from Biolin Scientific) was used as a sensor including a crystal resonator.

A silica sol prepared in a synthesis example and chemical solutions prepared in preparation examples were analyzed (pH value, electrical conductivity, DLS average particle diameter) using the following devices.
DLS average particle diameter (dynamic light scattering method particle diameter): a dynamic light scattering method particle diameter measurement device, Zetasizer Nano (commercially available from Spectris, Division of Malvern) was used.
pH: a pH meter (commercially available from DKK-TOA Corporation) was used.
Electrical conductivity: an electrical conductivity meter (commercially available from DKK-TOA Corporation) was used.
(Relationship between amount of change in vibration frequency when substance is adsorbed onto crystal resonator and mass of adhered substance)

The following Sauerbrey equation was used for determination.

ΔF=−(2Δmnf₀²)/(Aμ_{q}^{1/2}ρ_{q}^{1/2})
ΔF indicates the amount of change in vibration frequency of the crystal resonator,
f₀ indicates the fundamental vibration frequency,
n indicates the number of harmonic tones (odd harmonics),
A indicates the area of the metal thin film electrode attached to the crystal plate,
μ_{q} indicates the elastic modulus of the crystal, and is typically 2.947×10¹¹ dyn cm⁻²,
ρ_{q} indicates the density of the crystal, and is typically 2.648 g cm⁻³, and
Δm indicates the amount of the substance adhered per unit area of the electrode.

### Synthesis Example 1

1,200 g of an aqueous silica sol (Snowtex (product name) ST-O, commercially available from Nissan Chemical Corporation, silica concentration=20.5% by mass, an average particle diameter of 11.0 nm determined by the BET method, and an average particle diameter of 17.2 nm determined by the DLS method) and a magnetic stirrer were put into a 2,000 mL glass eggplant flask, and while stirring the magnetic stirrer, 191.0 g of 3-glycidoxypropyltrimethoxysilane (Dynasylan GLYMO, commercially available from Evonik Industries) was then added so that the mass ratio of the silane compound with respect to the silica (colloidal silica particles) in the aqueous silica sol was 0.78. Subsequently, a cooling pipe through which tap water flowed was installed at the top of the eggplant flask, and while refluxing, the aqueous sol was heated to 60° C. and held at 60° C. for 4 hours and then cooled. After cooling to room temperature, the aqueous sol was taken out.

1,391.0 g of an aqueous silica sol of Synthesis Example 1 which was subjected to surface treatment with a silane compound with a mass ratio of 0.78 of the silane compound with respect to the silica in the aqueous silica sol, a silica solid content of 21.2% by mass, a pH of 3.1, an electrical conductivity of 353 μS/cm, and a DLS average particle diameter of 23.2 nm was obtained.

### Preparation Example 1

A stirrer was put into a 120 mL styrofoam bottle, 9.0 g of pure water and 84.9 g of the aqueous silica sol subjected to surface treatment with the silane compound produced in Synthesis Example 1 were added, and stirred with a magnetic stirrer. Subsequently, while stirring the magnetic stirrer, 0.8 g of an anionic surfactant sodium a-olefin sulfonate (Riporan (registered trademark) LB-440, commercially available from Lion Specialty Chemicals Co., Ltd., an active component of 36.3%) was added and the mixture was stirred until it was completely dissolved. Subsequently, 0.30 g of an anionic surfactant sodium dodecyl sulfate (Sinolin (registered trademark) 90TK-T, commercially available from New Japan Chemical Co., Ltd.) was added, and the mixture was stirred until it was completely dissolved. Subsequently, as a nonionic surfactant, 1.7 g of polyoxyethylene styrenated phenyl ether (NOIGEN (registered trademark) EA-157, commercially available from DKS Co., Ltd.) with HLB=14.3 diluted with pure water to make 70% of an active component was added, the mixture was stirred until it was completely dissolved, and thereby a chemical solution of Preparation Example 1 containing the silica sol and the surfactant was produced.

### Preparation Example 2

A stirrer was put into a 120 mL styrofoam bottle, 93.9 g of pure water was added, and stirred with a magnetic stirrer. Subsequently, while stirring the magnetic stirrer, 0.8 g of an anionic surfactant sodium a-olefin sulfonate (Riporan (registered trademark) LB-440, commercially available from Lion Specialty Chemicals Co., Ltd., an active component of 36.3%) was added, and the mixture was stirred until it was completely dissolved. Subsequently, 0.30 g of an anionic surfactant sodium dodecyl sulfate (Sinolin (registered trademark) 90TK-T, commercially available from New Japan Chemical Co., Ltd.) was added, and the mixture was stirred until it was completely dissolved. Subsequently, as a nonionic surfactant, 1.7 g of polyoxyethylene styrenated phenyl ether (NOIGEN (registered trademark) EA-157, commercially available from DKS Co., Ltd.) with HLB=14.3 diluted with pure water to make an active component of 70% was added, and the mixture was stirred until it was completely dissolved, and thereby a chemical solution of Preparation Example 2 having a total surfactant concentration of 1.8% was produced.

### Example 1

A standardized used edible oil coated sensor (commercially available from Biolin Scientific) was prepared (product number: QSX342, a sensor in which a silicon dioxide-containing layer was formed on a gold electrode on a crystal resonator, and additionally, 5.7 μg/cm² of an edible oil was applied onto the silicon dioxide-containing layer, and the crystal resonator had a diameter of 15 mm).

Using the chemical solution produced in Preparation Example 1, a test fluid 1 diluted with a 4% by mass brine solution was prepared so that the concentration of the aqueous silica sol contained in the chemical solution was 0.5% by mass, and the total surfactant concentration was 0.05%.

The sensor was set in a chamber, the test fluid 1 was sent into the chamber at a flow rate of 0.05 mL/min, and thus the edible oil (oil layer) applied onto the silicon dioxide-containing layer of the sensor and the test fluid 1 were brought into contact with each other.

Due to the interaction caused by the contact between the edible oil and the test fluid 1, the oil peeling effect (the effect of peeling off the edible oil on the silicon dioxide-containing layer) was quantified as the frequency change value (ΔF value) and the energy dissipation value (ΔD value) detected by the sensor.

Here, the fluid and the crystal resonator were brought into contact with each other at 25° C., and the resonance frequency of the crystal resonator was 25 MHz.

### Example 2

A standardized used edible oil coated sensor (commercially available from Biolin Scientific) was prepared (product number: QSX342, a sensor in which a silicon dioxide-containing layer was formed on a gold electrode on a crystal resonator, and additionally, 5.7 μg/cm² of an edible oil was applied onto the silicon dioxide-containing layer, and the crystal resonator had a diameter of 15 mm).

Using the chemical solution produced in Preparation Example 2, a test fluid 2 diluted with a 4% by mass brine solution so that the total surfactant concentration contained in the chemical solution was 0.05% was prepared.

The sensor was set in a chamber, the test fluid 2 was sent into the chamber at a flow rate of 0.05 mL/min, and thus the edible oil (oil layer) applied onto the silicon dioxide-containing layer of the sensor and the test fluid 2 were brought into contact with each other.

Due to the interaction caused by the contact between the edible oil and the test fluid 2, the oil peeling effect (the effect of peeling off the edible oil on the silicon dioxide-containing layer) was quantified as the ΔF value and the ΔD value detected by the sensor.

Here, the fluid and the crystal resonator were brought into contact with each other at 25° C., and the resonance frequency of the crystal resonator was 25 MHz.

### Example 3

The oil peeling effect was quantified in the same manner as in Example 1 except that the test fluid 1 diluted with a 4% by mass brine solution prepared in Example 1 was sent into the chamber at a flow rate of 0.1 mL/min. Here, the fluid and the crystal resonator were brought into contact with each other at 25° C., and the resonance frequency of the crystal resonator was 25 MHz.

### Example 4

The oil peeling effect was quantified in the same manner as in Example 2 except that the test fluid 2 diluted with a 4% by mass brine solution prepared in Example 2 was sent into the chamber at a flow rate of 0.1 mL/min. Here, the fluid and the crystal resonator were brought into contact with each other at 25° C., and the resonance frequency of the crystal resonator was 25 MHz.

### Example 5

A test fluid 3 diluted with a 4% by mass brine solution was prepared so that the concentration of the aqueous silica sol (product name ST-O, commercially available from Nissan Chemical Corporation, a pH of 2.6, a silica concentration of 20.5% by mass, an average primary particle diameter of 11.0 nm determined by the BET method, and an average particle diameter of 17.2 nm determined by the DLS method) was 0.5% by mass.

The sensor was set in a chamber in the same manner as in Example 1 except that the test fluid 3 was used, and the oil peeling effect was quantified in the same manner as in Example 1 except that the test fluid 3 was sent into the chamber at a flow rate of 0.05 mL/min. Here, the fluid and the crystal resonator were brought into contact with each other at 25° C., and the resonance frequency of the crystal resonator was 25 MHz.

### Example 6

A silica (SiO₂)-coated sensor (commercially available from Biolin Scientific) was prepared (product number QSX303, a sensor in which a silicon dioxide-containing layer was formed on a gold electrode on a crystal resonator, and the crystal resonator had a diameter of 15 mm). The F value of the sensor at 25 MHz in air was 24722760.

A coating solution diluted with tetrahydrofuran so that the concentration of Light Sweet Azeri Crude Oil purchased from ONTA was 1.0% by mass was prepared. The coating solution was diluted twice with toluene and added dropwise to the sensor, and then spin-coated at 1,000 rpm for 30 seconds. The obtained sensor was baked on a hot plate at 100° C. for 5 minutes to obtain a crude oil coated sensor. The F value of the crude oil coated sensor at 25 MHz in air was 24722168. Since the difference from the F value before application was ΔF=−592, the amount of the crude oil applied onto the sensor after baking was 2.1 μg/cm² based on the Sauerbrey equation.

The obtained crude oil coated sensor was set in a chamber, the test fluid 1 prepared in Example 1 was sent into the chamber at a flow rate of 0.1 mL/min, and thus the crude oil (oil layer) applied onto the silicon dioxide-containing layer of the sensor and the test fluid 1 were brought into contact with each other.

Due to the interaction caused by the contact between the crude oil and the test fluid 1, the oil peeling effect (effect of peeling off the crude oil on the silicon dioxide-containing layer) was quantified as the ΔF value and the ΔD value detected by the sensor.

Here, the fluid and the crystal resonator were brought into contact with each other at 25° C., and the resonance frequency of the crystal resonator was 15 MHz.

### Example 7

The oil peeling effect was quantified in the same manner as in Example 6 except that the resonance frequency of the crystal resonator was 25 MHz.

### Example 8

The oil peeling effect was quantified in the same manner as in Example 6 except that the resonance frequency of the crystal resonator was 65 MHz.

### Example 9

A silica (SiO₂)-coated sensor (commercially available from Biolin Scientific) was prepared (product number QSX303, a sensor in which a silicon dioxide-containing layer was formed on a gold electrode on a crystal resonator, and the crystal resonator had a diameter of 15 mm). The F value of the sensor at 25 MHz in air was 24718857.

A coating solution diluted with tetrahydrofuran so that the concentration of Light Sweet Azeri Crude Oil purchased from ONTA was 0.5% by mass was prepared. The coating solution was diluted twice with toluene and added dropwise to the sensor, and then spin-coated at 1,000 rpm for 30 seconds. The obtained sensor was baked on a hot plate at 100° C. for 5 minutes to obtain a crude oil coated sensor. The F value of the crude oil coated sensor at 25 MHz in air was 24718493. Since the difference from the F value before application was ΔF=−364, the amount of the crude oil applied onto the sensor after baking was 1.3 μg/cm² based on the Sauerbrey equation.

The obtained crude oil coated sensor was set in a chamber, the test fluid 1 prepared in Example 1 was sent into the chamber at a flow rate of 0.1 mL/min, and thus the crude oil (oil layer) applied onto the silicon dioxide-containing layer of the sensor and the test fluid 1 were brought into contact with each other.

Due to the interaction caused by the contact between the crude oil and the test fluid 1, the oil peeling effect (effect of peeling off the crude oil on the silicon dioxide-containing layer) was quantified as the ΔF value and the ΔD value detected by the sensor. Here, the fluid and the crystal resonator were brought into contact with each other at 25° C., and the resonance frequency of the crystal resonator was 25 MHz. Here, the amount of crude oil components remaining on the sensor after baking was 1.3 μg/cm².

### Example 10

A silica (SiO₂)-coated sensor (commercially available from Biolin Scientific) was prepared (product number QSX303, a sensor in which a silicon dioxide-containing layer was formed on a gold electrode on a crystal resonator, and the crystal resonator had a diameter of 15 mm). The F value of the sensor at 25 MHz in air was 24718803.

A coating solution diluted with tetrahydrofuran so that the concentration of Light Sweet Azeri Crude Oil purchased from ONTA was 2.0% by mass was prepared. The coating solution was diluted twice with toluene and added dropwise to the sensor, and then spin-coated at 1,000 rpm for 30 seconds. The obtained sensor was baked on a hot plate at 100° C. for 5 minutes to obtain a crude oil coated sensor. The F value of the crude oil coated sensor at 25 MHz in air was 24717802. Since the difference from the F value before application was ΔF=−1001, the amount of the crude oil applied onto the sensor after baking was 3.5 μg/cm² based on the Sauerbrey equation.

The obtained crude oil coated sensor was set in a chamber, the test fluid 1 prepared in Example 1 was sent into the chamber at a flow rate of 0.1 mL/min, and thus the crude oil (oil layer) applied onto the silicon dioxide-containing layer of the sensor and the test fluid 1 were brought into contact with each other.

Due to the interaction caused by the contact between the crude oil and the test fluid 1, the oil peeling effect (effect of peeling off the crude oil on the silicon dioxide-containing layer) was quantified as the ΔF value and the ΔD value detected by the sensor. Here, the fluid and the crystal resonator were brought into contact with each other at 25° C., and the resonance frequency of the crystal resonator was 25 MHz.

### Example 11

A silica (SiO₂)-coated sensor (commercially available from Biolin Scientific) was prepared (product number QSX303, a sensor in which a silicon dioxide-containing layer was formed on a gold electrode on a crystal resonator, and the crystal resonator had a diameter of 15 mm). The F value of the sensor at 25 MHz in air was 24722610.

A coating solution diluted with tetrahydrofuran so that the concentration of Light Sweet Azeri Crude Oil purchased from ONTA was 1.0% by mass was prepared. The coating solution was diluted twice with toluene and added dropwise to the sensor, and then spin-coated at 1,000 rpm for 30 seconds. The obtained sensor was baked on a hot plate at 100° C. for 5 minutes to obtain a crude oil coated sensor. The F value of the crude oil coated sensor at 25 MHz in air was 24721749. Since the difference from the F value before application was ΔF=−861, the amount of the crude oil applied onto the sensor after baking was 3.0 μg/cm² based on the Sauerbrey equation.

The test fluid 2 used in Example 2 was prepared.

The sensor was set in a chamber, the test fluid 2 was sent into the chamber at a flow rate of 0.1 mL/min, and thus the crude oil (oil layer) applied onto the silicon dioxide-containing layer of the sensor and the test fluid 2 were brought into contact with each other.

Due to the interaction caused by the contact between the edible oil and the test fluid 2, the oil peeling effect (the effect of peeling off the edible oil on the silicon dioxide-containing layer) was quantified as the ΔF value and the ΔD value detected by the sensor.

Here, the fluid and the crystal resonator were brought into contact with each other at 25° C., and the resonance frequency of the crystal resonator was 25 MHz.

### Comparative Example 1

A standardized used edible oil coated sensor (commercially available from Biolin Scientific) was prepared (product number: QSX342, a sensor in which a silicon dioxide-containing layer was formed on a gold electrode on a crystal resonator, and additionally, 5.7 μg/cm² of an edible oil was applied onto the silicon dioxide-containing layer, and the crystal resonator had a diameter of 15 mm).

The sensor was set in a chamber, the 4% by mass brine solution was sent into the chamber at a flow rate of 0.05 mL/min, and thus the edible oil (oil layer) applied onto the silicon dioxide-containing layer of the sensor and the brine solution were brought into contact with each other.

Due to the interaction caused by the contact between the edible oil and the brine solution, the oil peeling effect was quantified as the ΔF value and the ΔD value detected by the sensor.

Here, the fluid and the crystal resonator were brought into contact with each other at 25° C., and the resonance frequency of the crystal resonator was 25 MHz.

### Comparative Example 2

A silica (SiO₂)-coated sensor (commercially available from Biolin Scientific) was prepared (product number QSX303, a sensor in which a silicon dioxide-containing layer was formed on a gold electrode on a crystal resonator, and additionally, 2.8 μg/cm² of a crude oil was applied onto the silicon dioxide-containing layer, and the crystal resonator had a diameter of 15 mm).

A coating solution diluted with tetrahydrofuran so that the concentration of Light Sweet Azeri Crude Oil purchased from ONTA was 1.0% by mass was prepared. The coating solution was diluted twice with toluene and added dropwise to the sensor, and then spin-coated at 1,000 rpm for 30 seconds. The obtained sensor was baked on a hot plate at 100° C. for 5 minutes to obtain a crude oil coated sensor.

The sensor was set in a chamber, the 4% by mass brine solution was sent into the chamber at a flow rate of 0.1 mL/min, and thus the crude oil (oil layer) applied onto the silicon dioxide-containing layer of the sensor and the brine solution were brought into contact with each other.

Due to the interaction caused by the contact between the crude oil and the brine solution, the oil peeling effect was quantified as the ΔF value and the ΔD value detected by the sensor. Here, the resonance frequency of the crystal resonator was 25 MHz.

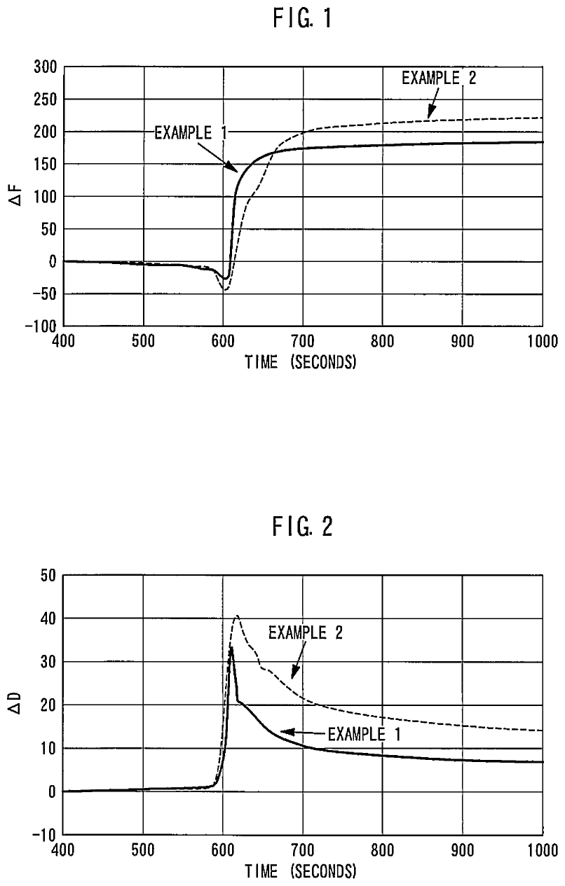

FIG. 1 is a diagram showing the change in the frequency change value (ΔF) detected in Example 1 and Example 2 over time from when sending of a liquid into the chamber starts. Here, during the measurement, zero correction was performed on a blank solution (brine solution alone).

As shown in FIG. 1, it was confirmed that, based on the frequency change value (ΔF value) indicating a change in the weight of the oil layer (edible oil) on the silicon dioxide-containing layer, Example 1 using the chemical solution for recovery (test fluid 1) of Preparation Example 1 caused a frequency change earlier than Example 2 using the chemical solution for recovery (test fluid 2) of Preparation Example 2. Therefore, it could be evaluated that the chemical solution for recovery used in Example 1 caused the oil peeling effect more quickly than the chemical solution for recovery used in Example 2.

In addition, in Example 1, the maximum value of the ΔF value was 180, and in Example 2, the maximum value of the ΔF value was 220.

FIG. 2 is a diagram showing the change in the energy dissipation value (ΔD) detected in Example 1 and Example 2 over time from when sending of a liquid into the chamber starts. Here, during the measurement, zero correction was performed on a blank solution (brine solution alone).

As shown in FIG. 2, it was confirmed that, based on the energy dissipation value (ΔD value) indicating an elastic modulus of the oil layer (edible oil) on the silicon dioxide-containing layer, in Example 1 using the chemical solution for recovery (test fluid 1) of Preparation Example 1, the rise of the ΔD value and the attenuation curve from the maximum were sharper than those of Example 2 using the chemical solution for recovery (test fluid 2) of Preparation Example 2. Therefore, it could be evaluated that the chemical solution for recovery used in Example 1 caused a change (improvement of film flexibility) in the oil layer at an earlier stage than the chemical solution for recovery used in Example 2.

In addition, in Example 1, the local maximum value of the ΔD value was 33, and in Example 2, the local maximum value of the ΔD value was 40.

In addition, in the results shown in FIG. 2, the time from when a change in the ΔD value started until the value reached a maximum was 586 seconds to 610 seconds (24 seconds) in Example 1, and 586 seconds to 618 seconds (32 seconds) in Example 2, and in Example 2, 1.33 times as much time as Example 1 was required.

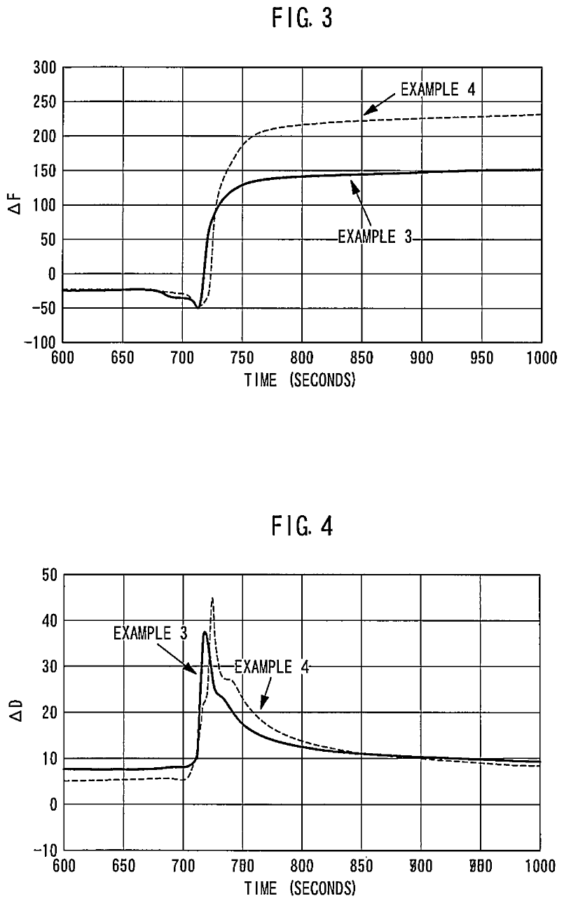

FIG. 3 is a diagram showing the change in the frequency change value (ΔF) detected in Example 3 and Example 4 over time from when sending of a liquid into the chamber starts. Here, during the measurement, zero correction was performed on a blank solution (brine solution alone).

As shown in FIG. 3, it was confirmed that, based on the frequency change value (ΔF value) indicating a change in the weight of the oil layer (edible oil) on the silicon dioxide-containing layer, Example 3 using the chemical solution for recovery (test fluid 1) of Preparation Example 1 caused a frequency change earlier than Example 4 using the chemical solution for recovery (test fluid 2) of Preparation Example 2. Therefore, it could be evaluated that the chemical solution for recovery used in Example 3 caused the oil peeling effect more quickly than the chemical solution for recovery used in Example 4.

In addition, in Example 3, the maximum value of the ΔF value was 150, and in Example 2, the maximum value of the ΔF value was 230.

In addition, comparing the ΔF values in FIG. 1 and FIG. 3, in Example 3 and Example 4, the flow rate of the chemical solution for recovery was twice that of Examples 1 and 2, and thus the oil peeling effect could be achieved earlier.

FIG. 4 is a diagram showing the change in the energy dissipation value (ΔD) detected in Example 3 and Example 4 over time from when sending of a liquid into the chamber starts. Here, during the measurement, zero correction was performed on a blank solution (brine solution alone).

As shown in FIG. 4, it was confirmed that, based on the energy dissipation value (ΔD value) indicating an elastic modulus of the oil layer (edible oil) on the silicon dioxide-containing layer, in Example 3 using the chemical solution for recovery (test fluid 1) of Preparation Example 1, the rise of the ΔD value and the attenuation curve from the maximum were sharper than those of Example 4 using the chemical solution for recovery (test fluid 2) of Preparation Example 2. Therefore, it could be evaluated that the chemical solution for recovery used in Example 3 caused a change (improvement of film flexibility) in the oil layer at an earlier stage than the chemical solution for recovery used in Example 4.

In addition, in Example 1, the local maximum value of the ΔD value was 38, and in Example 2, the local maximum value of the ΔD value was 45.

In addition, comparing the ΔD values in FIG. 2 and FIG. 4, it was confirmed that, in Examples 3 and 4, the flow rate of the chemical solution for recovery was twice that of Examples 1 and 2, and the change in the oil layer occurred earlier.

In addition, in the results shown in FIG. 4, the time from when a change in the ΔD value started until the value reached a maximum was 704 seconds to 719 seconds (15 seconds) in Example 3 and 704 seconds to 724 seconds (20 seconds) in Example 4, and in Example 4, 1.33 times as much time as Example 3 was required.

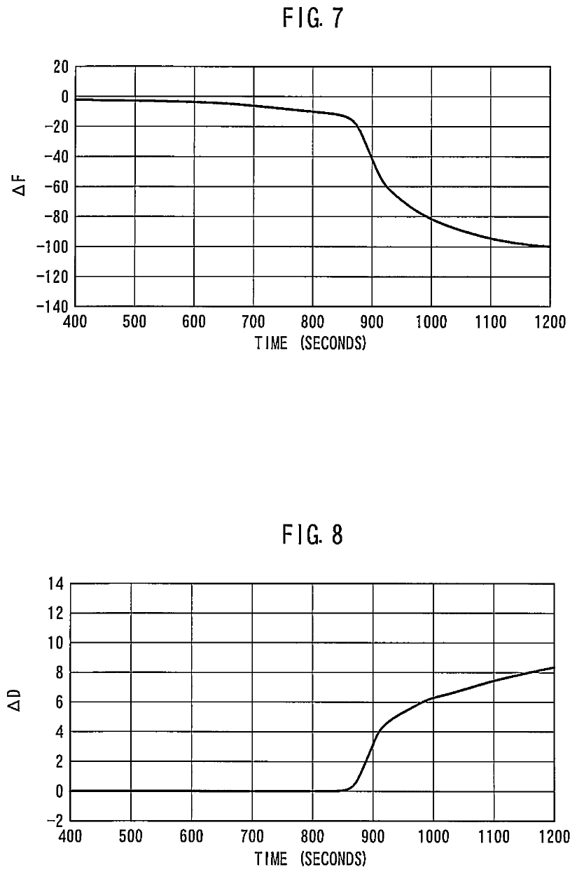

FIG. 7 and FIG. 8 are diagrams showing the change in the frequency change value (ΔF) (FIG. 7) or the energy dissipation value (ΔD) (FIG. 8) detected in Example 5 over time from when sending of a liquid into the chamber starts. Here, during the measurement, zero correction was performed on a blank solution (brine solution alone).

As shown in FIG. 7, it could be evaluated that, based on the frequency change value (ΔF value) indicating a change in the weight of the oil layer (edible oil) on the silicon dioxide-containing layer, the test fluid 3 had no effect of peeling off the edible oil. In addition, the ΔF value was a maximum of 0.

As shown in FIG. 8, it could be evaluated that, based on the energy dissipation value (ΔD value) indicating an elastic modulus of the oil layer (edible oil) on the silicon dioxide-containing layer, the test fluid 3 had an effect of swelling the edible oil. In addition, the local maximum value of the ΔD value was 8.4.

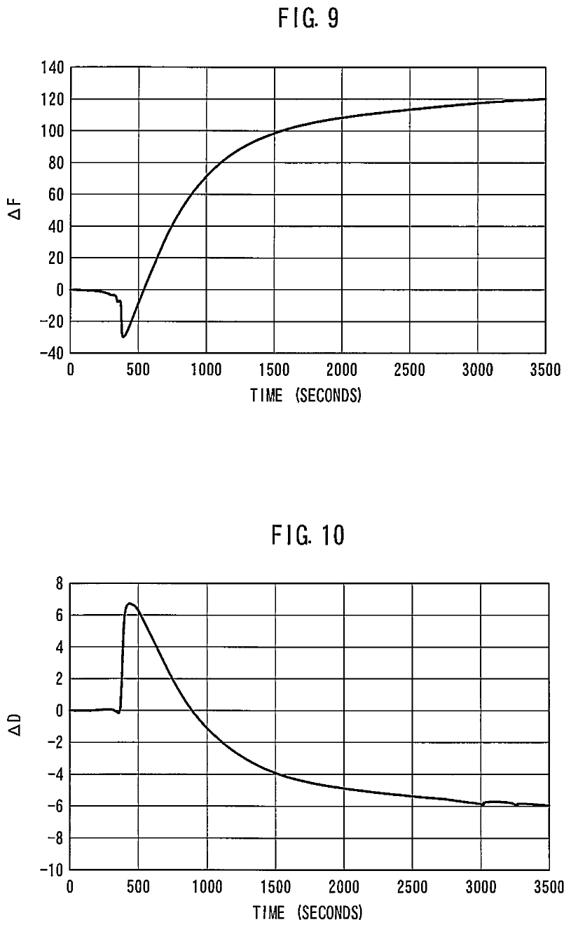

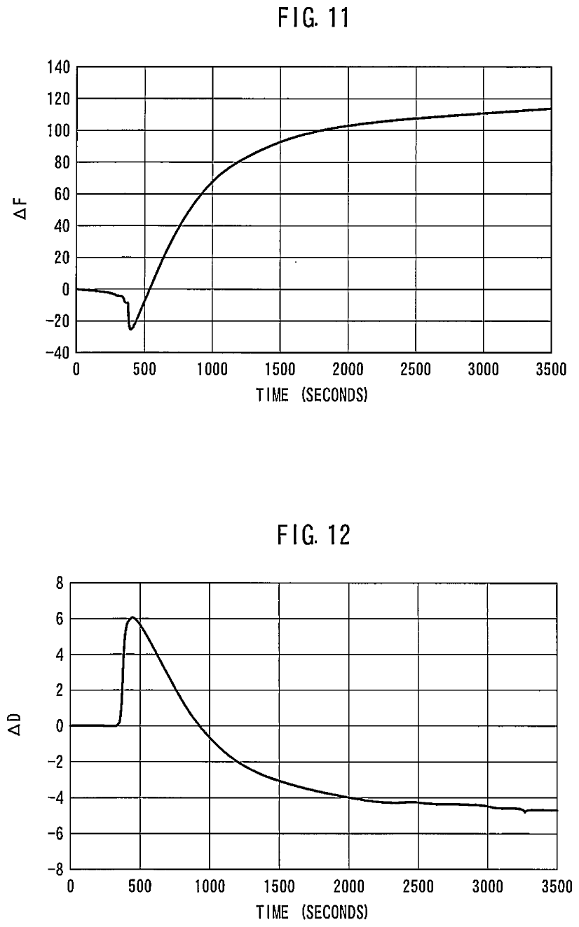

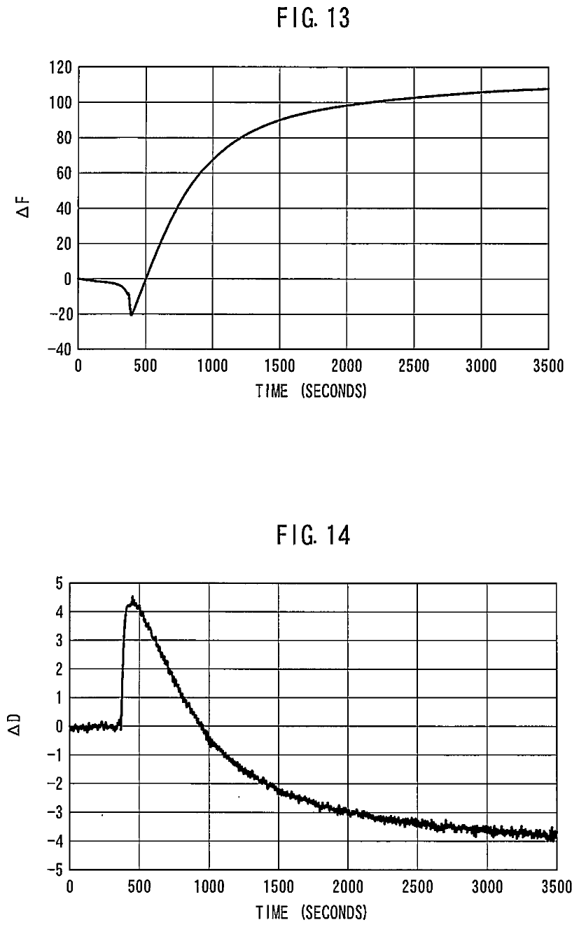

FIG. 9, FIG. 11, and FIG. 13 are diagrams showing the change in the frequency change value (ΔF) over time from when sending of a liquid into the chamber started detected in Example 6, Example 7, and Example 8, respectively. Here, during the measurement, zero correction was performed on a blank solution (brine solution alone).

As shown in FIG. 9, FIG. 11, and FIG. 13, it was found that, based on the frequency change value (ΔF value) indicating a change in the weight of the oil layer (crude oil) on the silicon dioxide-containing layer, the chemical solution for recovery (test fluid 1) of Preparation Example 1 had an effect of peeling off the crude oil.

It was found that the crude oil recovery performance could be evaluated regardless of the resonance frequency during measurement. Here, the maximum value of ΔF was 120 in Example 6, 118 in Example 7, and 117 in Example 8.

FIG. 10, FIG. 12 and FIG. 14 are diagrams showing a change in the energy dissipation value (ΔD) over time from when sending of a liquid into the chamber started detected in Example 6, Example 7, and Example 8, respectively. Here, during the measurement, zero correction was performed on a blank solution (brine solution alone).

As shown in FIG. 10, FIG. 12, and FIG. 14, it could be evaluated that, based on the energy dissipation value (ΔD value) indicating an elastic modulus of the oil layer (crude oil) on the silicon dioxide-containing layer, the chemical solution for recovery (test fluid 1) of Preparation Example 1 caused a change (improvement of film flexibility) in the oil layer (crude oil).

Here, the local maximum value of the ΔD value was 6.8 in Example 6, 6.0 in Example 7, and 4.3 in Example 8.

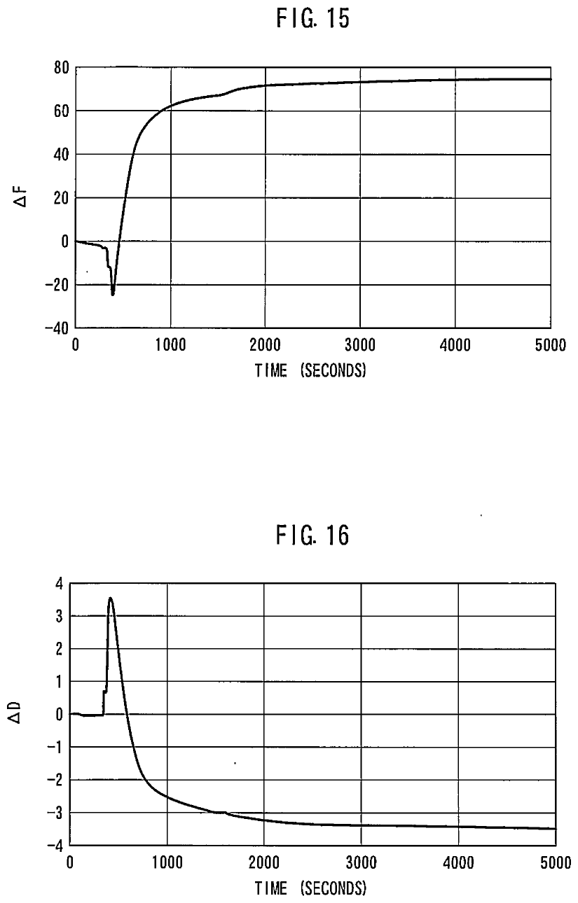

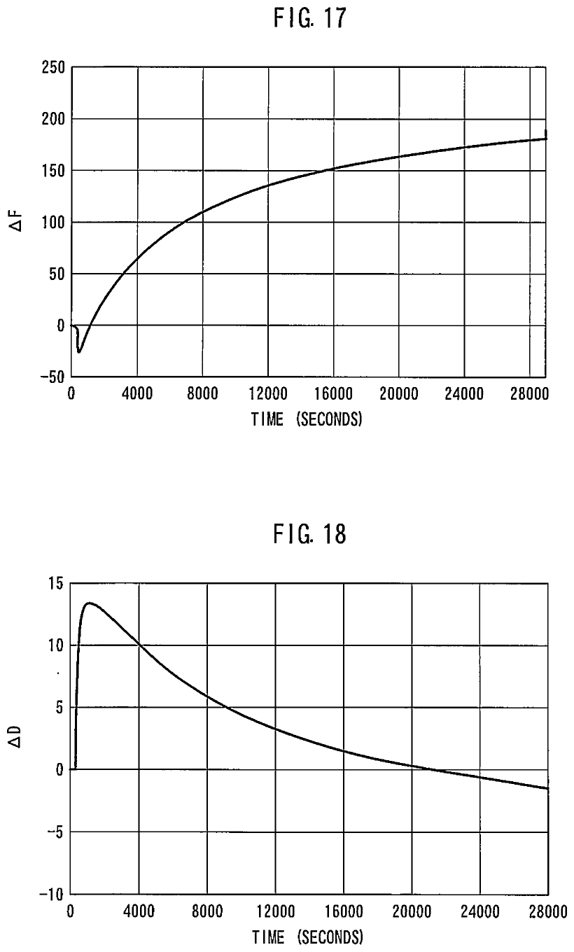

FIG. 15 and FIG. 17 are diagrams showing a change in the frequency change value (ΔF) over time from when sending of a liquid into the chamber started detected in Example 9 and Example 10, respectively. Here, during the measurement, zero correction was performed on a blank solution (brine solution alone).

It was found that the time taken for the frequency change value (ΔF value) indicating a change in the weight of the oil layer (crude oil) on the silicon dioxide-containing layer to become stable varied depending on the amount of the oil (crude oil) on the sensor. Here, the maximum value of the ΔF value was 74 in Example 9 and 181 in Example 10.

FIG. 16 and FIG. 18 are diagrams showing a change in the frequency change value (ΔD) over time from when sending of a liquid into the chamber started detected in Example 9 and Example 10, respectively. Here, during the measurement, zero correction was performed on a blank solution (brine solution alone).

It was found that the change in the energy dissipation value ΔD indicating an elastic modulus of the oil layer (crude oil) on the silicon dioxide-containing layer varied depending on the amount of the oil (crude oil) on the sensor. Here, the local maximum value of the ΔD value was 3.5 in Example 9 and 13.4 in Example 10.

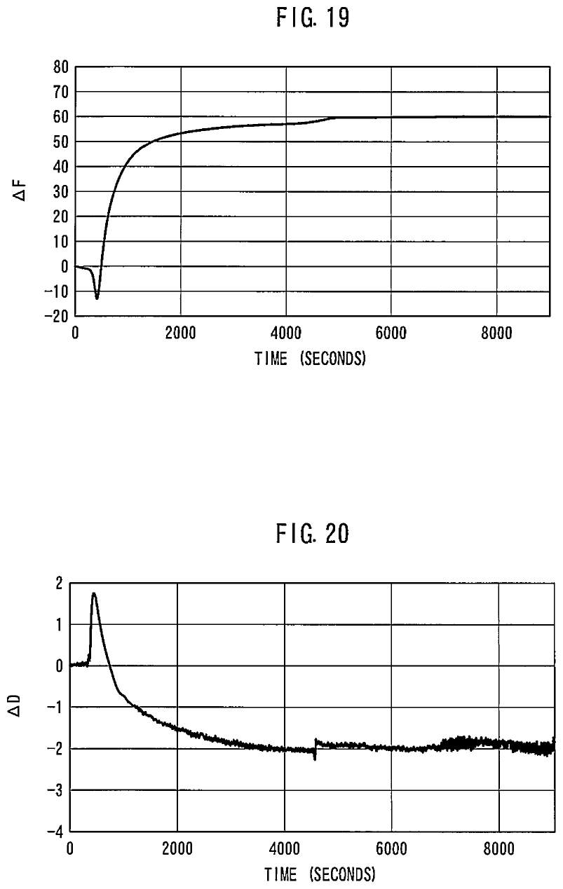

FIG. 19 and FIG. 20 are diagrams showing the change in the frequency change value (ΔF) (FIG. 19) or the energy dissipation value (ΔD) (FIG. 20) detected in Example 11 over time from when sending of a liquid into the chamber starts. Here, during the measurement, zero correction was performed on a blank solution (brine solution alone).

As shown in FIG. 19, it could be evaluated that, based on the frequency change value (ΔF value) indicating a change in the weight of the oil layer (crude oil) on the silicon dioxide-containing layer, the test fluid 2 had an effect of peeling off the crude oil. In addition, the ΔF value was a maximum of 61.

As shown in FIG. 20, it could be evaluated that, based on the energy dissipation value (ΔD value) indicating an elastic modulus of the oil layer (crude oil) on the silicon dioxide-containing layer, the test fluid 2 had an effect of swelling the crude oil. In addition, the local maximum value of the ΔD value was 1.8.

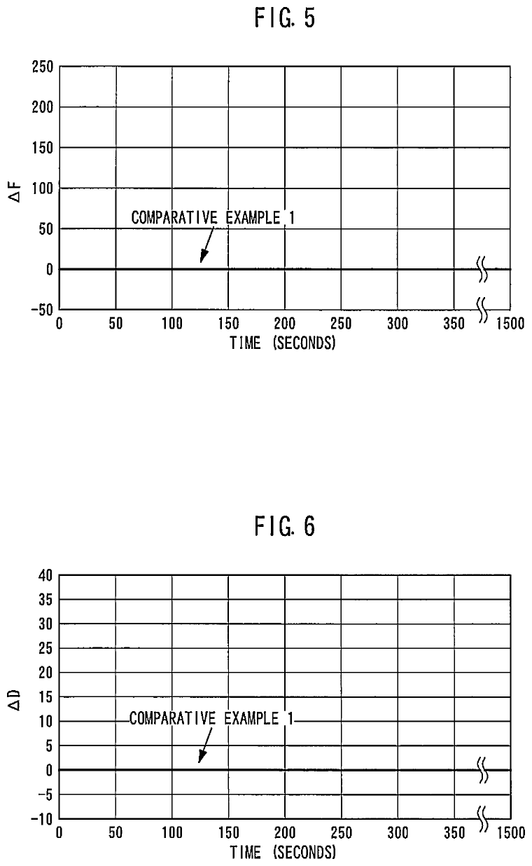

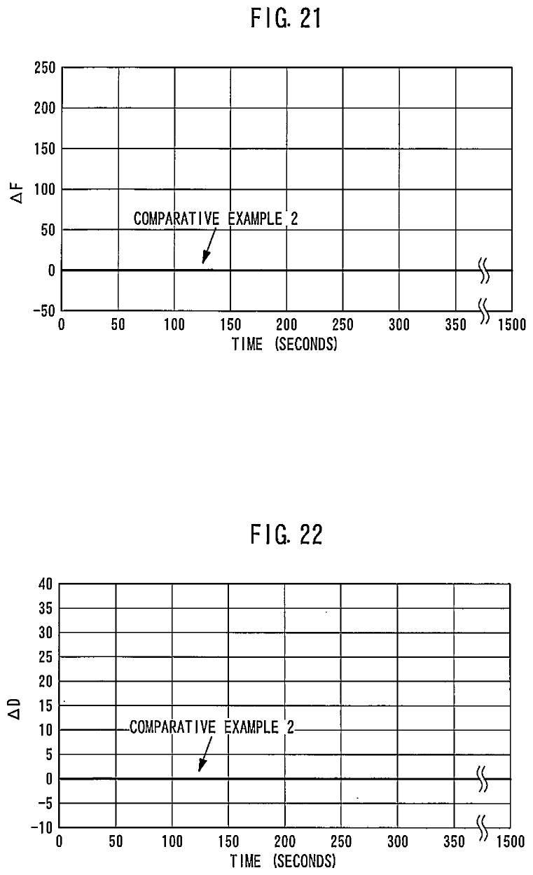

FIG. 5 and FIG. 21 are diagrams showing the change in the frequency change value (ΔF) detected in Comparative Example 1 and Comparative Example 2 over time from when sending of a liquid into the chamber starts.

As shown in FIG. 5 and FIG. 21, it was found that, based on the frequency change value (ΔF value) indicating a change in the weight of the oil layer (edible oil or crude oil) on the silicon dioxide-containing layer, no oil peeling effect was obtained with the brine solution (salt water).

FIG. 6 and FIG. 22 are diagrams showing the change in the frequency change value (ΔD) detected in Comparative Example 1 and Comparative Example 2 over time from when sending of a liquid into the chamber starts.

As shown in FIG. 6 and FIG. 22, it was found that, based on the frequency change value (ΔD value) indicating a change in the weight of the oil layer (edible oil or crude oil) on the silicon dioxide-containing layer, the brine solution (salt water) had no effect of swelling the oil layer.

In Comparative Example 1, the maximum value of ΔF was 1, and the local maximum value of the ΔD value was 1.

In Comparative Example 2, the maximum value of ΔF was 1, and the local maximum value of the ΔD value was 1.

Here, in Comparative Example 1 and Comparative Example 2, there was no oil recovery function, and the maximum value of the ΔF value was “1.” In addition, since there was no local maximum value for the AD value, the value was “1.”

ΔF_{A}/ΔF_{B} and ΔD_{A}/ΔD_{B} based on Examples 1 to 4 and Comparative Example 1 when an edible oil coated sensor was used are shown.

The ΔF_{A} value indicates the maximum value of a frequency change indicating a change in the weight of the oil layer, which was detected by the sensor upon contact with the fluid used in Examples 1 to 4,
the ΔD_{A} value indicates the local maximum value of the energy dissipation value indicating a change in the elastic modulus of the oil layer, which was detected by the sensor upon contact with the fluid used in Examples 1 to 4,
the ΔF_{B} value indicates the maximum value of a frequency change indicating a change in the weight of the oil layer, which was detected by the sensor upon contact with the fluid used in Comparative Example 1, and
the ΔD_{B} value indicates the local maximum value of the energy dissipation value indicating a change in the elastic modulus of the oil layer, which was detected by the sensor upon contact with the fluid used in Comparative Example 1.
ΔF_{A}/ΔF_{B}: 180 (Example 1), 220 (Example 2), 150 (Example 3), 230 (Example 4),
ΔD_{A}/ΔD_{B}: 33 (Example 1), 40 (Example 2), 38 (Example 3), 45 (Example 4),

ΔF_{A}/ΔF_{B} and ΔD_{A}/ΔD_{B} based on Examples 6 to 11 and Comparative Example 2 when a crude oil coated sensor was used are shown.

The ΔF_{A} value indicates the maximum value of a frequency change indicating a change in the weight of the oil layer, which was detected by the sensor upon contact with the fluid used in Examples 6 to 11,
the ΔD_{A} value indicates the local maximum value of the energy dissipation value indicating a change in the elastic modulus of the oil layer, which was detected by the sensor upon contact with the fluid used in Examples 6 to 11,
the ΔF_{B} value indicates the maximum value of a frequency change indicating a change in the weight of the oil layer, which was detected by the sensor upon contact with the fluid used in Comparative Example 2, and
the ΔD_{B} value indicates the local maximum value of the energy dissipation value indicating a change in the elastic modulus of the oil layer, which was detected by the sensor upon contact with the fluid used in Comparative Example 2.
ΔF_{A}/ΔF_{B}: 120 (Example 6), 118 (Example 7), 117 (Example 8), 74 (Example 9), 181 (Example 10), 61 (Example 11),
ΔD_{A}/ΔD_{B}: 6.6 (Example 6), 6.0 (Example 7), 4.3 (Example 8), 3.5 (Example 9), 13.4 (Example 10), 1.8 (Example 11)

T_{A} was 24 seconds (Example 1), 32 seconds (Example 2), 15 seconds (Example 3), 20 seconds (Example 4), 95 seconds (Example 6), 98 seconds (Example 7), 108 seconds (Example 8), 88 seconds (Example 9), 775 seconds (Example 10), 99 seconds (Example 11), and
T_{C} was at least 1,500 seconds or longer (Comparative Example 1, Comparative Example 2).

Here, the start time of the change in the ΔD_{A} value in T_{A} calculation was 586 seconds (Example 1, Example 2), 704 seconds (Example 3, Example 4), 339 seconds (Example 6, Example 7, Example 8), 334 seconds (Example 9), 344 seconds (Example 10), and 331 second (Example 11), and the start time of change in the ΔD_{C} value in T_{C} calculation was 0 seconds (Comparative Example 1, Comparative Example 2). Since there was no change between Comparative Example 1 and Comparative Example 2, it was thought the measurement start time was regarded as the change start, and the time T_{C} to reach the maximum was 1,500 seconds or longer.

### INDUSTRIAL APPLICABILITY

The present invention provides a method for measuring a change in a state caused by a change in a physical quantity such as a weight or elastic modulus of an adhered substance on an adhesion target using a QCM sensor, and when the ease of adhesion of the adhered substance on a specific adhesion target and the ease of peeling off are measured, it is possible to clarify the adsorption and desorption mechanism and provide useful information for a material design involving the adhesion target and the adhered substance under an external environment.

1. A measurement method for a change in a physical quantity of an adhered substance that changes due to external stimulation, comprising
measuring a change in a physical quantity of an adhered substance on an adhesion target by causing a detection unit in which an adhesion target (a) and an adhered substance (b) on the adhesion target (a) are applied onto a sensor including a crystal resonator in an overlapping manner to resonate in a medium (d), and measuring an amount of change in a resonance frequency of the crystal resonator caused by external stimulation (c) to the detection unit.

2. The measurement method according to claim 1,
wherein the external stimulation (c) is chemical injection or a temperature change.

3. The measurement method according to claim 1,
wherein the change in the physical quantity is a change in an elastic modulus of the adhered substance.

4. The measurement method according to claim 1,
wherein the change in the physical quantity is a change in an elastic modulus of a laminated part composed of the adhesion target and the adhered substance due to detachment of the adhered substance from the adhesion target.

5. The measurement method according to claim 1,
wherein the change in the physical quantity is a change in a weight of the adhered substance.

6. The measurement method according to claim 1,
wherein the medium (d) is a gas or a liquid.

7. The measurement method according to claim 1,
wherein the a (adhesion target), the b (adhered substance), the c (external stimulation), and the d (medium) are a (bedrock), b (oil), c (administration of a chemical solution for recovery), and d (salt water).

8. The measurement method according to claim 1,
wherein the a (adhesion target), the b (adhered substance), the c (external stimulation), and the d (medium) are a (substrate), b (contaminant), c (administration of a washing agent), and d (aqueous medium).

9. The measurement method according to claim 1,
wherein the a (adhesion target), the b (adhered substance), the c (external stimulation), and the d (medium) are a (polymerizable monomers on a substrate), b (polymerizable monomers in the medium), c (administration of a catalyst into the medium), and d (solvent).

10. The measurement method according to claim 1,
wherein the a (adhesion target), the b (adhered substance), the c (external stimulation), and the d (medium) are a (coating film on a substrate), b (water), c (temperature change), and d (atmosphere adjustment gas).

11. The measurement method according to claim 1,
wherein the a (adhesion target), the b (adhered substance), the c (external stimulation), and the d (medium) are a (coating film on a substrate), b (detection target gas), c (temperature change), and d (atmosphere adjustment gas).

12. The measurement method according to claim 1,
wherein the a (adhesion target) is a silicon dioxide-containing layer,
the b (adhered substance) is at least one oil selected from among a crude oil, a liquid hydrocarbon, and an edible oil,
the c (external stimulation) is administration of an aqueous chemical solution for recovery containing silica particles and a surfactant, and
the d (medium) is water or salt water, and
wherein the change in the physical quantity is a change in a weight of oil due to detachment from the silicon dioxide-containing layer.

13. The measurement method according to claim 1,
wherein the a (adhesion target) is a silicon dioxide-containing layer,
the b (adhered substance) is water in the silicon dioxide-containing layer,
the c (external stimulation) is a temperature change, and
the d (medium) is a humidity adjustment gas, and
wherein the change in the physical quantity is a change in a weight of water due to desorption from the silicon dioxide-containing layer.

14. The measurement method according to claim 1,
wherein the a (adhesion target) is a silicon dioxide-containing layer,
the b (adhered substance) is water in a humidity adjustment gas,
the c (external stimulation) is a temperature change,
the d (medium) is a humidity adjustment gas, and
the change in the physical quantity is a change in a weight of water due to adhesion to the silicon dioxide-containing layer.

15. The measurement method according to claim 2,
wherein the chemical injection is performed by administering a solution containing a drug at 0.01 to 5 ml/min.

16. The measurement method according to claim 1,
wherein the resonance frequency of the crystal resonator is in a range of 1 MHz to 100 MHz.

17. A device for measuring the change in the physical quantity according to claim 1.

18. A silica-containing chemical solution for oil recovery which satisfies a relationship of ΔF_{A}/ΔF_{B}=0.8 to 400 and ΔD_{A}/ΔD_{B}=0.8 to 100 when a detection unit including a sensor in which a silicon dioxide-containing layer corresponding to bedrock is formed on a sensor part having a diameter of 15 mm in which a gold electrode is wired on a crystal resonator, and an oil layer corresponding to a petroleum layer is adhered onto the silicon dioxide-containing layer at 0.5 to 10 μg/cm² is brought into contact with a fluid A containing, as components, salt water containing salts including sodium chloride at a concentration of 0.1 to 30% by mass and a silica-containing chemical solution for oil recovery or a fluid B containing the salt water but not containing the silica-containing chemical solution for oil recovery at a fluid flow rate of 0.01 to 5 mL/min at 25° C. and the sensor is resonated in a frequency range of 1 MHz to 100 MHz,
wherein a value of ΔF_{A} indicates a maximum value of a frequency change value ΔF indicating a change in a weight of the oil layer, which is detected by the sensor upon contact with the fluid A,
a value of ΔD_{A} indicates a local maximum value of an energy dissipation value ΔD indicating a change in an elastic modulus of the oil layer, which is detected by the sensor upon contact with the fluid A,
a value of ΔF_{B} indicates a maximum value of a frequency change value ΔF indicating a change in a weight of the oil layer, which is detected by the sensor upon contact with the fluid B, and
a value of ΔD_{B} indicates a local maximum value of an energy dissipation value ΔD indicating a change in an elastic modulus of the oil layer, which is detected by the sensor upon contact with the fluid B, and
wherein the silica-containing chemical solution for oil recovery contains 0.0001 to 50% by mass of a silica and 0.001 to 40% by mass of a surfactant with respect to a mass of the silica.

19. A silica-containing chemical solution for oil recovery which satisfies a relationship of T_{C}>T_{A} when a detection unit including a sensor in which a silicon dioxide-containing layer corresponding to bedrock is formed on a sensor part having a diameter of 15 mm in which a gold electrode is wired on a crystal resonator, and an oil layer corresponding to a petroleum layer is adhered onto the silicon dioxide-containing layer at 0.5to 10 μg/cm² is brought into contact with a fluid A containing, as components, salt water containing salts including sodium chloride at a concentration of 0.1 to 30% by mass and a silica-containing chemical solution for oil recovery or a fluid C containing the salt water and a silica-free chemical solution for oil recovery at a fluid flow rate of 0.01 to 5 ml/min at 25° C., and the sensor is resonated in a frequency range of 1 MHz to 100 MHz,
wherein
a value of T_{A} is a time from when a change in an energy dissipation value ΔD_{A} indicating a change in an elastic modulus of the oil layer starts until the energy dissipation value ΔD_{A} reaches a maximum, which is detected by the sensor upon contact with the fluid A, and
a value of T_{C} is a time from when a change in an energy dissipation value ΔD_{C} indicating a change in an elastic modulus of the oil layer (=ΔD_{B} value) starts until the energy dissipation value ΔD_{C} becomes a maximum, which is detected by the sensor upon contact with the fluid C.
